(19) United States
(12) Patent Application Publication
(10) Pub. No.: US 2025/0139549 A1
(43) Pub. Date: May 1, 2025

(54) INFORMATION PROCESSING SYSTEM AND METHOD OF INFORMATION PROCESSING

(71) Applicant: FRONTEO, Inc., Tokyo (JP)

(72) Inventors: Toru HISAMITSU, Tokyo (JP); Yuichi KICHIKAWA, Tokyo (JP)

(21) Appl. No.: 18/919,016

(22) Filed: Oct. 17, 2024

(30) Foreign Application Priority Data
Oct. 27, 2023 (JP) 2023-184589

(51) Int. Cl. G06Q 10/0631

(52) U.S. Cl. CPC G06Q 10/06315

(57) ABSTRACT

An information processing system includes: a network obtaining unit configured to obtain a first network in which a plurality of nodes corresponding to a plurality of entities are connected together by edges; and an influence-level calculating unit. Each of the plurality of nodes is provided with a tag including tag values, and for each of a plurality of paths including a reference node corresponding to an entity of interest in the first network, the influence-level calculating unit performs processing to determine a weight of the path, determine weights of tag transition patterns by distributing the weight of the path in accordance with a determined number of tag transition patterns, and upon receiving a given selection condition including at least a designated tag value, determine the influence level exerted upon the entity of interest in accordance with the weights of the tag transition patterns selected based on the given selection condition.

### CROSS-REFERENCE TO RELATED APPLICATION

The present application claims priority from Japanese Application JP2023-184589, filed Oct. 27, 2023, the content of which is hereby incorporated by reference into this application.

### BACKGROUND OF THE INVENTION

### 1. Field of the Invention

The present invention relates to, but not limited to, an information processing system and a method of information processing.

### 2. Description of the Related Art

Various conventional techniques are known for network analysis, such as supply chain analysis. A supply chain is a series of flow starting from the procurement of the raw materials and components of a product to the manufacture, inventory management, delivery, sale and consumption of the product. For instance, Japanese Patent No. 7034447 discloses an information processing system that analyzes, in a supply chain, a subnetwork including at least one of upstream and downstream subnetworks of a company of interest, and that displays the analyzed result.

### SUMMARY OF THE INVENTION

The conventional techniques, such as that in Japanese Patent No. 7034447, fail to disclose an index for a macroscopic bird's-eye view of the influence level of an attribute provided to a network node (e.g., an industrial classification or a belonging country in a supply chain network).

Some aspects of the present disclosure can provide, but not limited to, an information processing system and a method of information processing for appropriately assessing an influence level in a target network.

One aspect of the present disclosure is directed to an information processing system provided with the following: a network obtaining unit configured to obtain a first network in which a plurality of nodes corresponding one-to-one to a plurality of entities are connected together by edges each representing a trading relationship or a control relationship; and an influence-level calculating unit configured to calculate an influence level in a part or whole of the first network. Each of the plurality of nodes included in the first network is provided with a tag including one or more of a plurality of tag values. For each of a plurality of paths including a reference node corresponding to an entity of interest in the first network, the influence-level calculating unit performs processing to determine a weight of the path in accordance with the trading relationship or the control relationship between the plurality of nodes on the path, determine weights of one or more tag transition patterns by determining the one or more tag transition patterns in accordance with the one or more tag values of the node on the path, the one or more tag transition patterns each representing a transition of the one or more tag values along the path, and by distributing the weight of the path in accordance with a determined number of tag transition patterns, and upon receiving a given selection condition including at least a designated tag value, determine the influence level exerted upon the entity of interest in accordance with the weights of the one or more tag transition patterns selected based on the given selection condition.

Another aspect of the present disclosure is directed to a method of information processing that is performed by an information processing system. The method is provided with the following: obtaining a first network in which a plurality of nodes corresponding one-to-one to a plurality of entities are connected together by edges each representing a trading relationship or a control relationship; and calculating an influence level in a part or whole of the first network. Each of the plurality of nodes included in the first network is provided with a tag including one or more of a plurality of tag values. For each of a plurality of paths including a reference node corresponding to an entity of interest in the first network, the information processing system performs, in calculating the influence level, processing to determine a weight of the path in accordance with the trading relationship or the control relationship between the plurality of nodes on the path, determine weights of one or more tag transition patterns by determining the one or more tag transition patterns in accordance with the one or more tag values of the node on the path, the one or more tag transition patterns each representing a transition of the one or more tag values along the path, and by distributing the weight of the path in accordance with a determined number of tag transition patterns, and upon receiving a given selection condition including at least a designated tag value, determine the influence level exerted upon the entity of interest in accordance with the weights of the one or more tag transition patterns selected based on the given selection condition.

### BRIEF DESCRIPTION OF THE DRAWINGS

FIG. 1 illustrates an example of a system configuration including an information processing system according to an embodiment;

FIG. 2 is a functional block diagram illustrating an example of the detailed configuration of a server system;

FIG. 3 is a functional block diagram illustrating an example of the detailed configuration of a terminal device;

FIG. 4 is a flowchart schematically showing processing that is performed in the information processing system;

FIG. 5A is an example of the structure of data that is obtained on the basis of open information;

FIG. 5B illustrates an example of the structure of the data that is obtained on the basis of the open information;

FIG. 5C illustrates an example of part of a trading network that is obtained on the basis of the open information;

FIG. 6 is a schematic diagram illustrating the trading network;

FIG. 7 is a flowchart showing processing to determine a vectorial representation;

FIG. 8 is a flowchart showing processing to extract an upstream trading subnetwork;

FIG. 9A illustrates an example of part of a trading subnetwork;

FIG. 9B illustrates an example of part of the trading subnetwork;

FIG. 10 illustrates an example of the trading subnetwork;

FIG. 11A is a flowchart showing processing to determine the vectorial representation of a node;

FIG. 11B is a flowchart showing processing to determine the vectorial representation of the node;

FIG. 12A illustrates an example of flow amounts in the trading subnetwork;

FIG. 12B illustrates an example of with-phase flow amounts in the trading subnetwork;

FIG. 13 illustrates an example of a complex vector corresponding to a given node;

FIG. 14 illustrates an example of with-phase flow amounts in the trading subnetwork;

FIG. 15 is a flowchart showing processing to extract a supply chain network;

FIG. 16 illustrates an example of a supply chain network;

FIG. 17 illustrates an example of the supply chain network with a loop removed therefrom;

FIG. 18 is a table showing specific examples of the weight of a path, and specific examples of the weight of a transition pattern;

FIG. 19A is a table showing examples of a tag transition pattern selected when an industrial classification is designated;

FIG. 19B is a table showing examples of a tag transition pattern selected when an industrial classification is designated;

FIG. 20 is a table showing influence level examples corresponding to an industrial classification and a distance from an entity of interest;

FIG. 21 illustrates a treemap example showing the influence levels of individual industrial classifications;

FIG. 22 is a table showing examples of a frequency corresponding to an industrial classification and a distance from an entity of interest;

FIG. 23 illustrates a treemap example showing the frequencies of the individual industrial classifications;

FIG. 24 illustrates an example of a supply chain network;

FIG. 25 is a table showing examples of a weight corresponding to an industrial classification, a country, and a distance from an entity of interest;

FIG. 26 is a table showing influence level examples corresponding to combinations of an industrial classification and a country;

FIG. 27 illustrates a treemap example showing the influence levels of individual combinations of an industrial classification and a country;

FIG. 28 is a table showing examples of an influence level corresponding to a country;

FIG. 29 is a table showing specific examples of the weight of a tag transition pattern with a tag value as a company ID;

FIG. 30A is a table showing examples of a tag transition pattern selected when a company ID is designated;

FIG. 30B is a table showing an example of a tag transition pattern selected when a company ID is designated;

FIG. 31 is a table showing influence level examples corresponding to company IDs;

FIG. 32 illustrates a treemap example showing the influence levels of the individual company IDs;

FIG. 33 illustrates a specific shareholding network example; and

FIG. 34 illustrates a network example when there are a plurality of entities of interest.

### DETAILED DESCRIPTION OF THE INVENTION

An embodiment will be described with reference to the drawings. Throughout the drawings, identical or equivalent constituents will be denoted by the same signs, and the description of redundancies about such constituents will be omitted. Note that this embodiment described below will not unduly limit the contents recited in the claims. Furthermore, not all of the configurations described in this embodiment are necessarily essential constituent features of the present disclosure.

### 1. Example of System Configuration

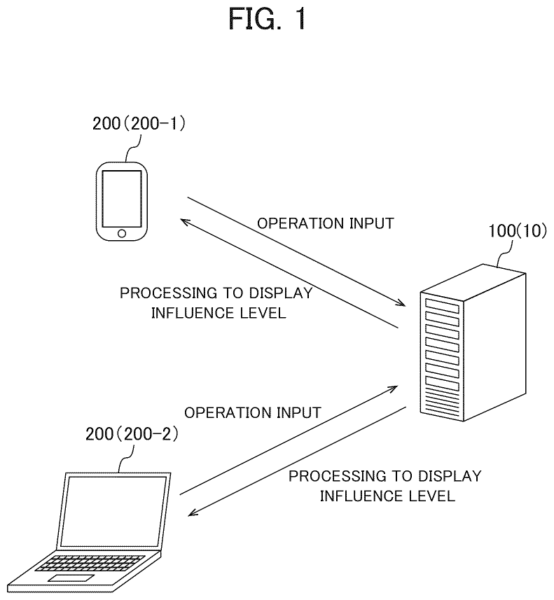

FIG. 1 illustrates an example of a system configuration including an information processing system 10 according to an embodiment. The system according to this embodiment includes a server system 100 and a terminal device 200. It is noted that the system configuration including the information processing system 10 is not limited to that in FIG. 1; the system can be modified in various manners such that, for instance, the configuration may be omitted partly, or another configuration may be added. Although FIG. 1 illustrates, by way of example, the terminal device 200 composed of two terminal devices, which are a terminal device 200-1 and a terminal device 200-2, the terminal device 200 may be composed of any number of terminal devices.

The information processing system 10 according to this embodiment corresponds to the server system 100 for instance. It is noted that the technique in this embodiment is not limited to the foregoing; the information processing system 10 may execute a process, which will be described in the Specification, through distributed processing by the use of the server system 100 and another device. For instance, the information processing system 10 according to this embodiment may be implemented through distributed processing by the use of the server system 100 and terminal device 200. The Specification will describe an instance where the information processing system 10 is a server system 100.

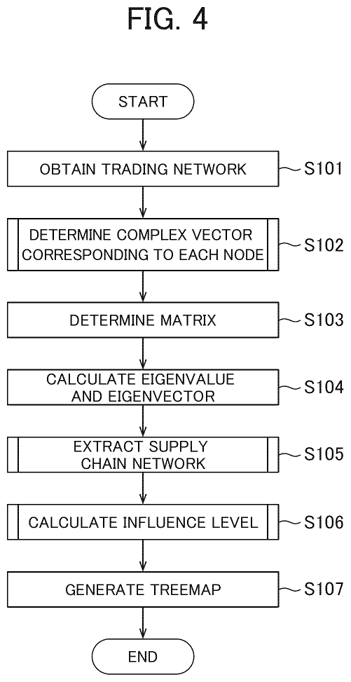

The server system 100 may be a single server or may include a plurality of servers. For instance, the server system 100 may include a database server and an application server. The database server stores various kinds of data, including a first network 121 and a complex vector, both of which will be described later on. The application server executes processing that will be described later on with reference to, but not limited to, FIGS. 4, 7, 8, 11A, 11B, and 15. It is noted that the plurality of servers herein may be physical servers or virtual servers. It is also noted that when virtual servers are used, they may be provided in a single physical server or distributed to a plurality of physical servers. As described above, the specific configuration of the server system 100 according to this embodiment can be modified in various manners.

The server system 100 communicates with the terminal device 200-1 and terminal device 200-2 over, for instance, a network. Hereinafter, a plurality of terminal devices will be simply referred to as a terminal device 200 unless these terminal devices have to be distinguished from each other. The network, although being herein a public communication network, such as the Internet, may be a local area network (LAN) or other things.

The terminal device 200 is a device that is used by a user who uses the information processing system 10. The terminal device 200 may be a personal computer (PC), a mobile terminal device, such as a smartphone, or any other like device having a function that will be described in the Specification.

The information processing system 10 according to this embodiment is an open-source intelligence (OSINT) system for, but not limited to, collecting and analyzing data related to a target by the use of, for instance, open information. The open information herein includes various kinds of information widely accessible and legally available. Examples of the open information may include securities reports, inter-industry relations tables, official announcements of a government, news reports on countries and companies, and supply chain databases. Further, the open information may include various kinds of information that are transmitted and received via a social networking service (SNS). For instance, the SNS may include services that allow texts, images or other things to be posted, and the open information in this embodiment may include these texts or images or include their results obtained through natural language processing, image processing or other processing.

The server system 100 generates nodes including various attributes on the basis of the open information. A single node represents a given entity. Although an example of the entity herein is a company, the entity may include another organization, such as a public agency, or include an individual. Attributes provided to a node are various kinds of information, such as the entity's name, nationality, business field, industrial classification, trading partners, and trading goods, that are determined based on the open information. For example, a node is provided with a tag as metadata. This tag includes the attribute values of the foregoing various attributes. When a node representing an entity is a company, the node is provided with attributes related to this company. It is noted that the attributes herein may include, but not limited to, sales, the number of employees, shareholders and their capital contribution ratios, and board members. In this embodiment, at least an industrial classification among these attributes is provided to a node. The industrial classification is the kind of an industry classified by a characteristic of the industry. Industrial classification codes, for instance, may be used as an industrial classification. The industrial classification codes are information with a code, such as “01”, assigned to individual industries classified into several fields. The industrial classification codes, although being the North American Industry Classification System (NAICS) for instance, may be another classification code, such as the International Standard Industrial Classification or the Japan Standard Industrial Classification.

When there is a relationship between a given node and another node, the given node and other node are connected together by an edge having a direction. For instance, let a given company provide (sell) a trading product of some kind to another company. In this case, a node corresponding to the other company, and a node corresponding to the given company are connected together by an edge provided with an attribute representing the product's buy-sell relationship (distribution relationship). The edge is herein an edge having a direction from an influencing entity to an influenced entity, that is, for instance, from a seller to a buyer of a product of some kind. That is, the edge represents a trading relationship in which a supply source company of a product is associated with a supply destination company of the product. In addition, the attribute provided to the edge is not limited to the product; various kinds of information, including, a start company, an end company, and a product as well as its price and the quantity (number) of trading products, can be included. It is noted that the information about the product is not an essential attribute that is to be provided to the edge and can be thus omitted. It is also noted that the same holds true for the other information pieces, such as the start company; these information pieces may be provided to the edge as attributes or may be omitted.

The server system 100 in the technique according to this embodiment obtains an entity network (first network), which is a network in which a plurality of nodes representing a plurality of entities are connected together by a plurality of edges each representing a trading relationship or a control relationship. Since the edges have directions, the entity network is a directed graph. The server system 100 performs processing to conduct an analysis based on the entity network and present the analyzed result. For instance, the terminal device 200 is a device that is used by a user who uses a service provided by the OSINT system. For instance, the user uses the terminal device 200 to send a request to the server system 100, which is the information processing system 10, to conduct an analysis of some kind. The server system 100 conducts an analysis based on an entity network and transmits the analyzed result to the terminal device 200.

When the entity network is a network representing a company-to-company trading relationship, there are two kinds of paths in the entity network: (A) a chain (upstream) pertaining to the trading of various items actually related to the company's product as components and materials and/or a chain (downstream) pertaining to the trading of the company's product; and (B) a chain in which multiple trading matters not directly pertaining to the company are linked by chance. As such, this embodiment will describe an entity network representing a trading relationship obtained based on open information as a trading network, and a part of the entity network pertaining to substantial trading on a given company as a supply chain network. That is, the trading network is a network including both (A) and (B), and the supply chain network pertaining to the given company is a network presumably including (A) without (B). The server system 100 may perform processing to extract the supply chain network from the trading network.

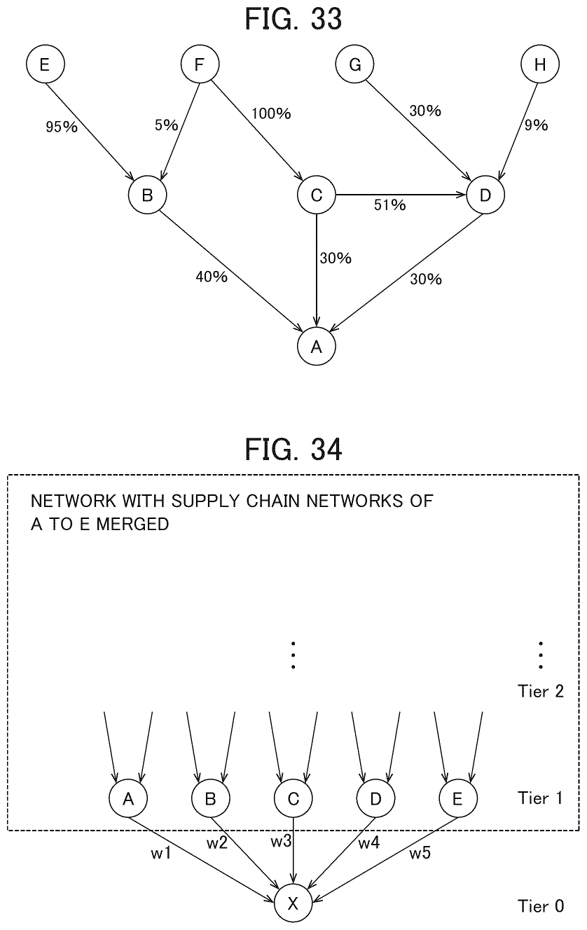

It is noted that as will be described later on with reference to FIG. 33, networks that undergo processing in this embodiment are not limited to a trading network and a supply chain network. For instance, the entity network may be a network representing an entity-to-entity control relationship. To be more specific, the entity network may be a shareholding network representing a company-to-company stock-based control relationship.

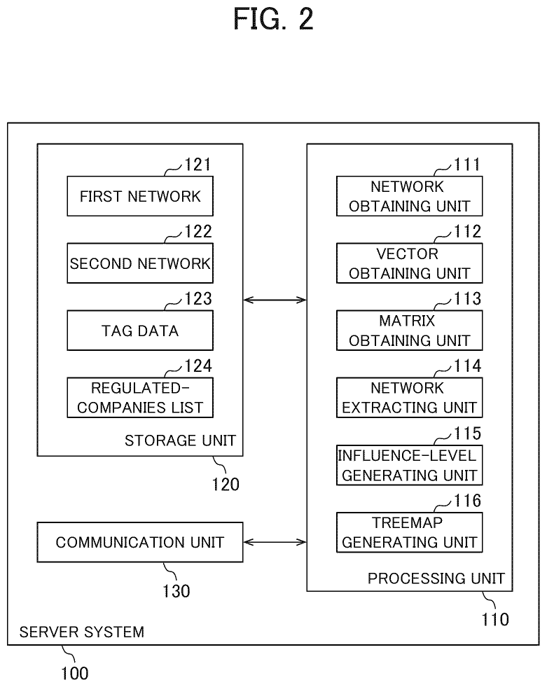

FIG. 2 is a functional block diagram illustrating an example of the detailed configuration of the server system 100. The server system 100 includes, as illustrated in FIG. 2 for instance, a processing unit 110, a storage unit 120, and a communication unit 130. It is noted that the configuration of the server system 100 is not limited to the example in FIG. 2; the configuration can be subjected to various modifications, such as omitting part of the configuration, or adding another configuration.

The processing unit 110 according to this embodiment is composed of hardware below. The hardware can include at least one of a digital-signal processing circuit and an analog-signal processing circuit. For instance, the hardware can be composed of one or more circuit devices mounted on a circuit board, or one or more circuit elements mounted on the same. Example of one or more circuit devices include an integrated circuit (IC) and a field-programmable gate array (FPGA). Examples of one or more circuit elements include a resistor and a capacitor.

The processing unit 110 may be also implemented in the form of a processor below. The server system 100 according to this embodiment includes a memory that stores information, and a processor that operates on the basis of the information stored in the memory. Examples of the information include a program and various kinds of data. The program may include a program to cause the server system 100 to execute processing that will be described in the Specification. The processor includes hardware. The processor can be various kinds of processors, including a central processing unit (CPU), a graphics processing unit (GPU), and a digital signal processor (DSP). The memory may be a semiconductor memory, such as a static random access memory (SRAM), a dynamic random access memory (DRAM), or a flash memory; alternatively, the memory may be a resistor; alternatively, the memory may be a magnetic storage device, such as a hard disk drive (HDD); alternatively, the memory may be an optical storage device, such as an optical disc device. For instance, the memory stores a computer-readable instruction, which is executed by the processor to thus implement the function of the processing unit 110 as a process. The instruction herein may be a set of instructions constituting the program, or an instruction for instructing a hardware circuit of the processor to operate.

The processing unit 110 includes, for instance, a network obtaining unit 111, a vector obtaining unit 112, a matrix obtaining unit 113, a network extracting unit 114, an influence-level calculating unit 115, and a treemap generating unit 116. It is noted that the processing unit 110 does not need to include all the constituents illustrated in FIG. 2. For instance, the processing unit 110 may obtain a shareholding network as an entity network and generate a treemap targeted on the whole of the shareholding network (the details will be described later on with reference to FIG. 33). In this case, the vector obtaining unit 112, matrix obtaining unit 113, and network extracting unit 114, and other units, which are all constituents related to the extraction of a second network 122 (in a narrow sense, a supply chain network), may be omitted.

The network obtaining unit 111 obtains the first network 121 in which a plurality of nodes corresponding one-to-one to a plurality of entities are connected together by edges each representing a trading relationship or a control relationship. For instance, the network obtaining unit 111 may generate an entity network on the basis of open information and define the entity network as the first network 121. The open information includes trading relationship information in which a supply source company of a product is associated with a supply destination company of the product, or control relationship information indicating, but not limited to, the ratio of shareholding. The network obtaining unit 111 stores the generated first network 121 in the storage unit 120. It is noted that the first network 121 may be generated by a system that is different from the information processing system 10 according to this embodiment. The network obtaining unit 111 in this case may perform processing to obtain a generated result from this different system.

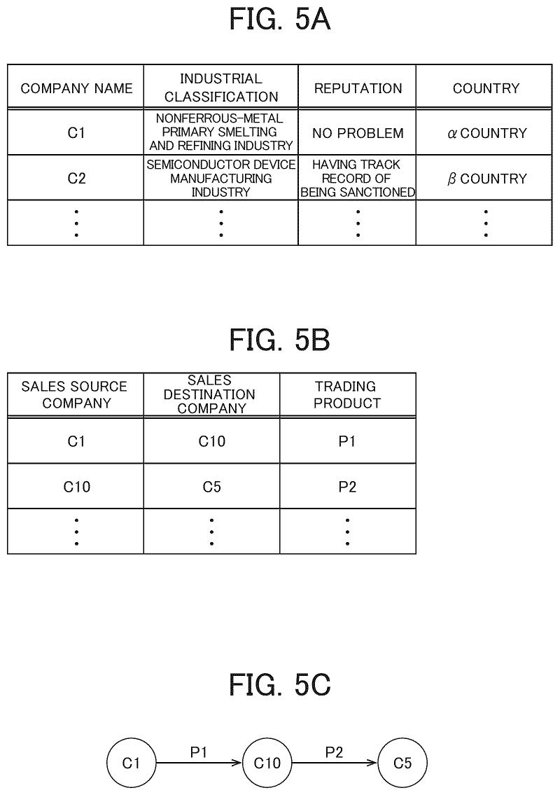

The network obtaining unit 111 may obtain a network in which a plurality of nodes corresponding to a plurality of companies are connected together, as the first network 121 in accordance with the trading relationships between the companies, as will be described later on with reference to FIGS. 5A to 5C for instance.

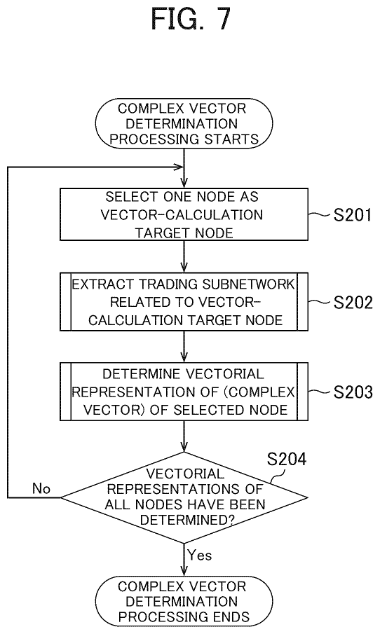

The vector obtaining unit 112 obtains the vectorial representation (complex vector) of each of the nodes included in the first network 121. To be specific, the vector obtaining unit 112 selects any one of the plurality of nodes as a vector-calculation target node and determines, for each of the plurality of nodes, a complex vector representing the relationship of this vector-calculation target node with another one of the plurality of nodes by assigning a complex number having a phase corresponding to the distance to the vector-calculation target node, and having an absolute value corresponding to the amount of flow going to or coming from the vector-calculation target node. How to determine the vector representation will be described later on with reference to FIGS. 7 to 14 and others. The vector obtaining unit 112 stores the obtained complex vector of each of the plurality of nodes in the storage unit 120.

The matrix obtaining unit 113 determines a complex correlation matrix C on the basis of the complex vector of each of the plurality of nodes obtained by the vector obtaining unit 112. The matrix obtaining unit 113 also determines an eigenvalue and an eigenvector by subjecting the complex correlation matrix C to eigenvalue decomposition.

The network extracting unit 114 extracts the second network 122, which is a part of the first network 121, on the basis of the complex vector, which represents each of the plurality of nodes. To be specific, the network extracting unit 114 may extract a supply chain network representing the substantial trading relationship of a given company as the second network 122 from a trading network (first network 121) on the basis of the eigenvector.

The influence-level calculating unit 115 calculates the influence level in a part or whole of the first network 121. A target that undergoes this influence level calculation may be the first network 121 per se or the second network 122.

To be specific, the influence-level calculating unit 115 may preform processing (1) to (3) below for each of a plurality of paths including a reference node corresponding to an entity of interest in a target network. The entity of interest corresponds to, for instance, a company that undergoes analysis and is input by the user of the terminal device 200.
(1) Processing to determine the weight of the path in accordance with a trading relationship or a control relationship between nodes on the path.
(2) Processing to determine the weights of one or more tag transition patterns by determining one or more tag transition patterns in accordance with the tag value of a node on the path, one or more tag transition patterns each representing a transition of the tag value along the path, and by distributing the weight of the path in accordance with a determined number of tag transition patterns.
(3) Processing to, upon receiving a given selection condition including at least a designated tag value, determine the influence level exerted upon the entity of interest in accordance with the weights of one or more tag transition patterns selected based on the given selection condition.

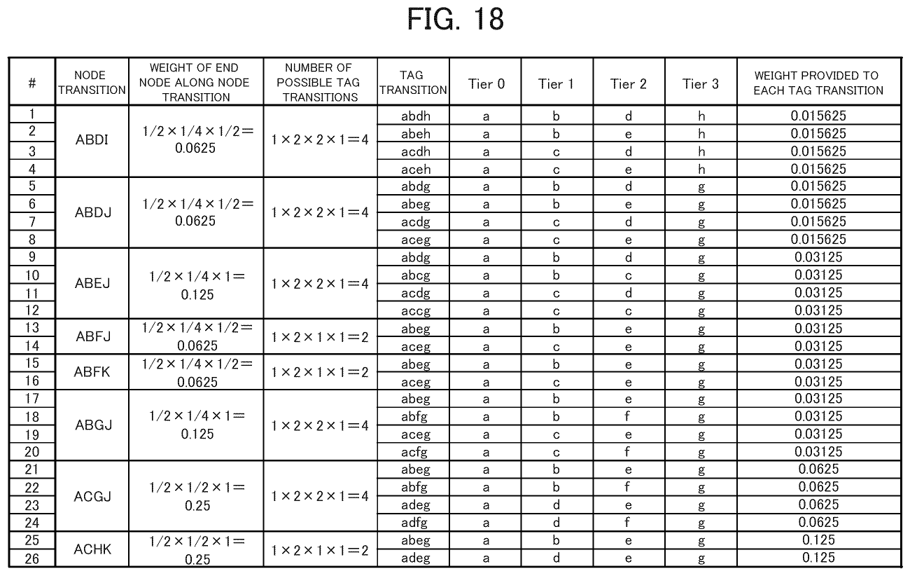

The weight of a path and the weight of one or more tag transition patterns will be detailed with reference to FIG. 18.

The selection condition is a condition for specifying selection/non-selection for each of a plurality of tag transition patterns. The selection condition may be, for example, a condition related to one kind of attribute, a condition related to a plurality of kinds of attribute, or a condition related to a combination of an attribute and a tier. The tier denotes the shortest distance from a reference node corresponding to an entity of interest in a target network.

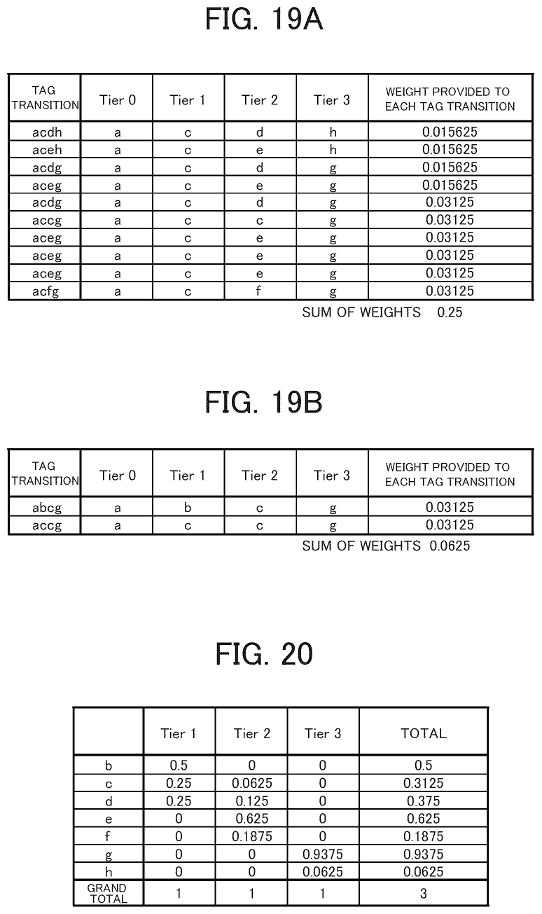

The tag transition patterns selected based on the selection condition correspond to a plurality of tag transition patterns that will be described later on with reference to FIGS. 19A and 19B for example. The influence level is information about, but not limited to, the sum of the weights provided to the respective selected tag transition patterns, as will be described later on with reference to FIGS. 19A and 19B for example.

As described above, the influence-level calculating unit 115 according to this embodiment performs processing to determine the weight for each path in a target network, followed by determining the weights of tag transition patterns by distributing the weight, and further determining the influence level in the network through, but not limited to, selection of a tag transition pattern and addition of the weight based on a selection condition. The processing in the influence-level calculating unit 115 will be detailed later on.

The treemap generating unit 116 generates a treemap showing the influence levels calculated by the influence-level calculating unit 115. The treemap is displayed on, for instance, a display unit 240 of the terminal device 200.

The storage unit 120 is the working region of the processing unit 110 and stores various kinds of information. The storage unit 120 can be implemented in the form of various kinds of memory; the memory may be a semiconductor memory, such as an SRAM, a DRAM, a ROM, and a flash memory; alternatively, the memory may be a resistor; alternatively, the memory may be a magnetic storage device, such as a hard disk drive; alternatively, the memory may be an optical storage device, such as an optical disc drive.

The storage unit 120 stores the first network 121 obtained by the network obtaining unit 111 for instance. The storage unit 120 also stores the second network 122 extracted by the network extracting unit 114. Further, the storage unit 120 may store open information, such as securities reports and inter-industry relations tables, as information indicating a trading relationship or a control relationship. For instance, the storage unit 120 also stores, but not limited to, tag data 123 and a regulated-companies list 124. The tag data 123 is tag-related information and is, for instance, a set of attribute values (candidate tag values) in a given attribute. The tag data 123 may be an industrial classification code for instance. It is noted that a tag may include various kinds of information, such as a country, a company ID, the category of an entity, and that tag data may include information about these tags. The regulated-companies list 124 is information for specifying a company having a problem in view of, for example, the ESG. Other than the foregoing, the storage unit 120 can store various kinds of information pertaining to the processing that is executed in this embodiment.

The communication unit 130 is an interface for communication over a network and includes, for instance, an antenna, a radio frequency (RF) circuit, and a baseband circuit. The communication unit 130 may operate under the control of the processing unit 110 or include a communication controlling processor that is different from the processing unit 110. The communication unit 130 is an interface for performing communication in accordance with, for instance, the transmission control protocol/Internet protocol (TCP/IP). It is noted that the specific communication scheme can be modified in various manners.

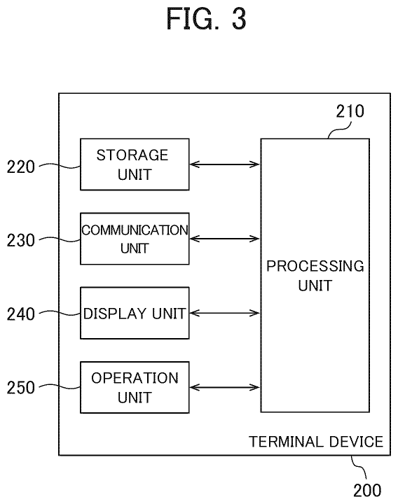

FIG. 3 is a block diagram illustrating an example of the detailed configuration of the terminal device 200. The terminal device 200 includes a processing unit 210, a storage unit 220, a communication unit 230, the display unit 240, and an operation unit 250.

The processing unit 210 is composed of hardware including at least one of a digital-signal processing circuit and an analog-signal processing circuit. Further, the processing unit 210 may be implemented in the form of a processor. The processor can be various processors, such as a CPU, a GPU, and a DSP. The processor executes an instruction stored in the memory of the terminal device 200, so that the function of the processing unit 210 is implemented in the form of a process.

The storage unit 220 is the working region of the processing unit 210 and is implemented in the form of various memories, such as an SRAM, a DRAM, and a ROM.

The communication unit 230 is an interface for communication over a network and includes, for instance, an antenna, an RF circuit, and a baseband circuit. The communication unit 230 communicates with the server system 100 over, for instance, a network.

The display unit 240 is an interface that displays various kinds of information. The display unit 240 may be a liquid crystal display, an organic EL display, or a display that operates under any other scheme. The operation unit 250 is an interface that receives an input operated by the user. The operation unit 250 may be, but not limited to, buttons provided in the terminal device 200. Further, the display unit 240 and operation unit 250 may be combined together to constitute a touch panel.

As described above, the information processing system 10 according to this embodiment includes the network obtaining unit 111 and the influence-level calculating unit 115. Moreover, when a node included in the first network 121 is provided with a tag including one or more of a plurality of tag values, the influence-level calculating unit 115 executes the foregoing processing (1) to (3).

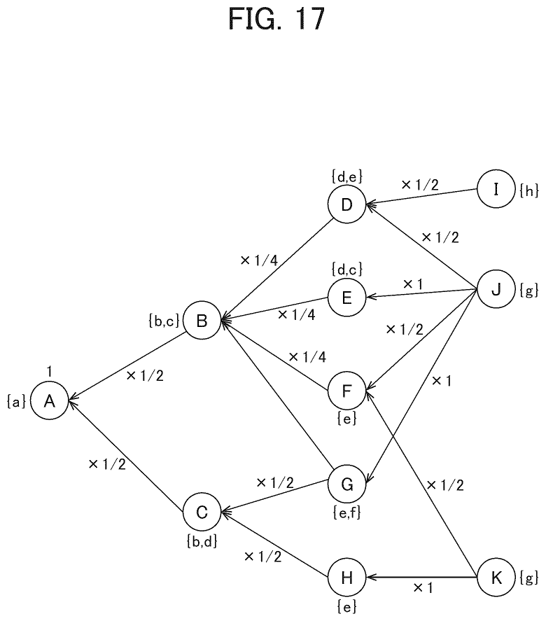

As will be described later on with reference to FIGS. 17, 18 and others, the weight of a path and the weight of a tag transition pattern can be determined through an easy operation, and even if the distance from a node representing an entity of interest is a distance of a certain degree, there is a low probability that the amount of calculation increases excessively. Thus, the technique according to this embodiment can determine how much an entity of interest is influenced by an entity having a designated tag value, with a bird's-eye view of a wide range (in a narrow sense, the entire) of a target network. In this embodiment, once the weight of a path and the weight of a tag transition pattern are calculated, the influence level can be easily recalculated even after a change in the selection condition; accordingly, a detailed analysis can be conducted by receiving an input to designate, in detail, the kind of an attribute that should be focused on and its attribute value (tag value).

Furthermore, the technique according to this embodiment enables an operation of the weight of a tag transition pattern and a calculation of the influence level to be executed once the weight of the path is calculated. Thus, a processing target network in the technique according to this embodiment is not limited to a trading network and a supply chain network; it can be broadened to various networks in which a path can undergo an operation on weight (weight at the end node on the path).

Further, the processing that is performed by the information processing system 10 according to this embodiment may be, in part or in whole, implemented in the form of a program. The processing that is performed by the information processing system 10 is, in a narrow sense, processing that is performed by the processing unit 110 of the server system 100 but may include processing that is performed by the processing unit 210 of the terminal device 200.

The program according to this embodiment can be stored in a non-transitory information storing medium (information storing device), an example of which is a computer-readable medium. The information storing medium can be implemented in the form of, but not limited to, an optical disk, a memory card, an HDD, or a semiconductor memory. The semiconductor memory is a ROM for instance. The processing unit 110 and others perform various processes in this embodiment based on programs stored in the information storing medium. That is, the information storing medium stores a program for causing a computer to function as the processing unit 110 and others. The computer is a device provided with an input device, a processing unit, a storage unit, and an output unit. To be specific, the program according to this embodiment is a program for causing a computer to execute individual process steps that will be described later on with reference to FIG. 4 and others.

The technique in this embodiment is also applicable to a method of information processing including process steps described below. The method of information processing includes the following steps that are performed by the information processing system 100: obtaining a first network in which a plurality of nodes corresponding one-to-one to a plurality of entities are connected together by edges each representing a trading relationship or a control relationship; and calculating an influence level in a part or whole of the first network. Each of the plurality of nodes included in the first network is provided with a tag including one or more of a plurality of tag values. In the method of information processing, the step of calculating the influence level includes the following steps performed for each of a plurality of paths including a reference node corresponding to an entity of interest in the first network: determining the weight of the path in accordance with the trading relationship or control relationship between the plurality of nodes on the path; determining the weights of one or more tag transition patterns by determining the one or more tag transition patterns in accordance with the one or more tag values of the node on the path, the one or more tag transition patterns each representing a transition of the one or more tag values along the path, and by distributing the weight of the path in accordance with a determined number of tag transition patterns; and upon receiving a given selection condition including at least a designated tag value, determining the influence level exerted upon the entity of interest in accordance with the weights of the one or more tag transition patterns selected based on the given selection condition.

### 2. Details of Processing

The processing in this embodiment will be detailed. The following describes an instance where the first network 121 is a trading network in which a plurality of nodes corresponding one-to-one to a plurality of companies are connected together by edges each representing a trading relationship, and where the second network 122 is a supply chain network representing a supply chain of a company of interest. Doing so enables the influence level to be determined as information for recognizing the supply chain network of the company of interest with a bird's-eye view. It is noted that processing targeted on another network will be described separately with reference to FIG. 33.

### 2.1 Overall Flow

FIG. 4 is a flowchart schematically illustrating processing that is executed in the information processing system 10 according to this embodiment.

In Step S101, the network obtaining unit 111 firstly obtains a trading network, which is the first network 121. The network obtaining unit 111 stores the trading network in the storage unit 120.

In Step S102, the vector obtaining unit 112 determines a vectorial representation for each of a plurality of nodes included in the trading network. The vector obtaining unit 112 stores the determined vectorial representation in the storage unit 120.

In Step S103, the matrix obtaining unit 113 determines a complex correlation matrix C in accordance with the vectorial representation. In Step S104, the matrix obtaining unit 113 subjects the complex correlation matrix C to eigenvalue decomposition to determine an eigenvalue and an eigenvector. The matrix obtaining unit 113 stores at least the eigenvector in the storage unit 120.

In Step S105, the network extracting unit 114 extracts a supply chain network, which is the second network 122, from the trading network in accordance with the eigenvector. For instance, the network extracting unit 114 may extract the supply chain network of a company that is an entity of interest.

In Step S106, the influence-level calculating unit 115 calculates the influence level in the supply chain network extracted in Step S105. To be specific, the influence-level calculating unit 115 executes the foregoing processing (1) to (3) sequentially.

In Step S107, the treemap generating unit 116 generates a treemap showing the influence levels obtained in Step S106. For example, the treemap generating unit 116 determines the influence levels of a plurality of individual attribute values (tag values) included in a given attribute and generates a treemap in accordance with the relationship of degree between the influence levels. Although not illustrated in FIG. 4, the processing unit 110 includes a display control unit; this display control unit may control the display unit 240 of the terminal device 200 to display the treemap.

The following details processing in each step.

### 2.2 Obtainment of Trading Network

Processing to obtain a trading network, which corresponds to Step S101 in FIG. 4, will be described. The network obtaining unit 111 may generate the trading network on the basis of open information. The open information includes information, such as securities reports and press releases.

The network obtaining unit 111 specifies, for each of many companies, various kinds of information, such as the name, nationality, business field, business partners and trading goods of the company. The network obtaining unit 111 may also specify, but not limited to, the number of employees, shareholders as well as their capital contribution ratio, and board members of each company on the basis of the open information.

The network obtaining unit 111 may also obtain reputation information indicating a reputation of each company on the basis of the open information. For instance, the reputation information is information indicating, but not limited to, whether a target company has a problem or a history of being sanctioned in view of environment, social, and governance (ESG). For instance, the reputation information may be information indicating, but not limited to, that a target company is a company violated export regulations, a company handling conflict minerals, a company involved in slave labor, or a company involved in illegal logging. Further, the open information may be a document issued by, for instance, a government institute, and the reputation information may be information indicating whether a target company is subjected to restriction on trading with a predetermined country or other things. Further, as earlier described, the open information may include information about the SNS; the reputation information herein may be information determined based on the SNS. For instance, the network obtaining unit 111 may obtain the reputation information in accordance with SNS information sent from the official account of, for instance, a company. Further, the SNS information that is used in the technique in this embodiment shall not be limited to information sent from an official account. For instance, on the SNS, when a predetermined number or more of users have sent out the name of a given company along with a word, such as “conflict minerals”, “slave labor”, or “illegal logging”, the given company may be associated with negative reputation information.

FIGS. 5A and 5B illustrate examples of the structure of data that is obtained based on open information. As illustrated in FIG. 5A, the network obtaining unit 111 obtains information in which each company included in the open information is associated with a company name, an industrial classification, a reputation, and a nationality.

The company name is, for instance, text data indicating the name of a target company. The industrial classification is information indicating the business field of the target company. The reputation is, as described above, information indicating whether the target company has a problem in view of the ESG. The nationality is information indicating a country to which the target company belongs.

It is noted that although the industrial classification is shown in the form of a text in FIG. 5A, information indicating the industrial classification may be denoted by an industrial classification code. For the Japan Standard Industrial Classification for instance, a code “231” is assigned to the primary smelting and refining of non-ferrous metals, and a code “2813” is assigned to the semiconductor devices. It is noted that the industrial classification may be another classification, such as NAICS, as earlier described. For convenience in description, the industrial classification will be hereinafter a text indicating a classification name. It is noted that a classification name in the following processing can be substituted for an industrial classification code. Further, the storage unit 120 may contain the tag data 123, as illustrated in FIG. 2, which is information in which, for instance, a classification name and a classification code in NAICS are associated with each other. The processing unit 110 may execute conversion processing between the classification name and classification code in accordance with the tag data 123.

Further, as illustrated in FIG. 5B, the network obtaining unit 111 obtains information indicating company-to-company trading on the basis of the open information. For instance, the trading relationship information included in the open information is the information illustrated in FIG. 5B, or information capable of specifying the information illustrated in FIG. 5B. The information indicating the company-to-company trading is information in which, for instance, information for identifying a sales source company, information for identifying a sales destination company, and information for identifying a product to be traded are associated with one another.

Based on these information items, the network obtaining unit 111 generates a trading network in the form of a directed graph in which companies are represented by nodes, and in which their trading relationships are represented by edges.

FIG. 5C illustrates part of a trading network generated based on the trading relationship shown in FIG. 5B. FIG. 5B shows a relationship in which a company C1 sells a product P1 to a company C10. The network obtaining unit 111 in this case provides an edge directed from C1 to C10, between a node representing the company C1 and a node representing the company C10. As illustrated in FIG. 5A, the node representing the company C1 is associated with the company name “C1”, and further with information on items, such as an industrial classification, a reputation, and a nationality. The same applies to the node representing the company C10. Further, the edge directed from C1 to C10 is associated with P1, which denotes a traded product. It is noted that the network obtaining unit 111 may obtain information, such as a trading volume and a trading price, on the basis of open information, and that these information items may be associated with an edge.

FIG. 5B also shows a relationship in which the company C10 sells a product P2 to a company C5. The network obtaining unit 111 in this case provides an edge directed from C10 to C5, between the node representing the company C10 and a node representing the company C5. Each of the nodes is associated with the information illustrated in FIG. 5A, and each of the edges is associated with information on a traded product and other things.

It is noted that as earlier described, a provider (seller) of a product of some sort is referred to as “upstream” in a trading network, which is a directed graph, and a receiver (buyer) of a product of some sort is referred to as “downstream” in the same. It is noted that the same definition of upstream and downstream is also applied to a supply chain network, which will be described later on.

A trading network herein is, in a narrow sense, a network including nodes corresponding to all companies included in open information that is to be processed. Thus, the trading network may be a network including so many nodes, and the number of nodes may be approximately several thousand or more. It is noted that the configuration of the trading network may be modified in various manners; an example is deleting some of the companies included in the open information.

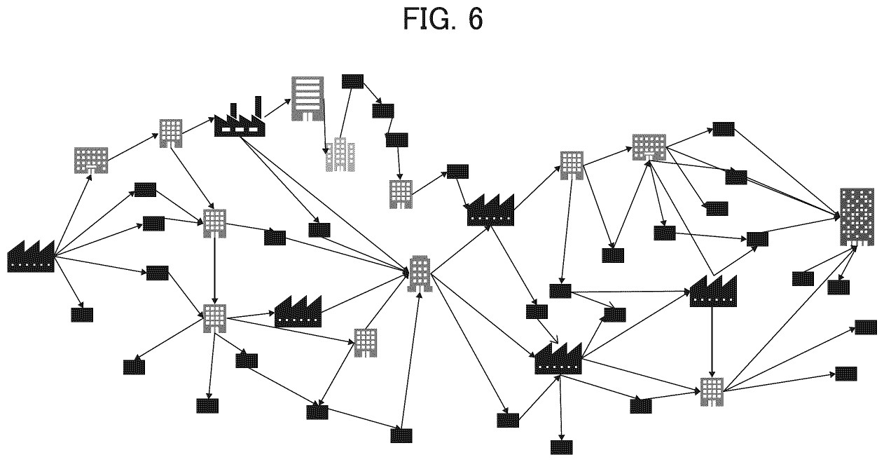

FIG. 6 is a schematic diagram illustrating a trading network. As illustrated in FIG. 6, the trading network is a directed graph in which a plurality of nodes are connected together by edges representing trading relationships. It is noted that for easy illustration, the nodes in FIG. 6 are depicted in different shapes, depending on whether the nodes represent manufacturing plants, distribution hubs, or other things. As earlier described, the information obtained includes, but not limited to, the names, industrial classifications of companies corresponding to the respective nodes; hence, the display mode of the trading network can be changed depending on, for instance, the industrial classifications. It is noted that the technique in this embodiment does not necessarily require such node shape control.

It is noted that FIGS. 5A and 5B illustrate examples of the data structure related to the trading network; a specific data structure shall not be limited to these examples. For instance, although FIGS. 5A and 5B illustrate an instance where table data, such as a relational database, is used, data having another structure may be used. Further, even in the use of table data, the number of tables shall not be limited to two; the tables may be managed in the form of either one combined table, or three or more divided tables. Furthermore, some of the items illustrated in FIGS. 5A and 5B may be omitted, or another item may be added. For instance, the network obtaining unit 111 may obtain information indicating company names, industrial classification codes, and buy-sell directions and may omit other information.

### 2.3 Calculation of Vectorial Representation

### 2.3.1 Extraction of Trading Network Related to Vector-Calculation Target Node

FIG. 7 is a flowchart showing a process for determining a complex vector, which corresponds to in Step S102 in FIG. 4. Upon the start of this process, the vector obtaining unit 112 firstly selects one of a plurality of nodes included in the trading network as a vector-calculation target node.

In Step S202, the vector obtaining unit 112 extracts a trading subnetwork related to the vector-calculation target node. The trading subnetwork is a network included in the trading network and including the vector-calculation target node.

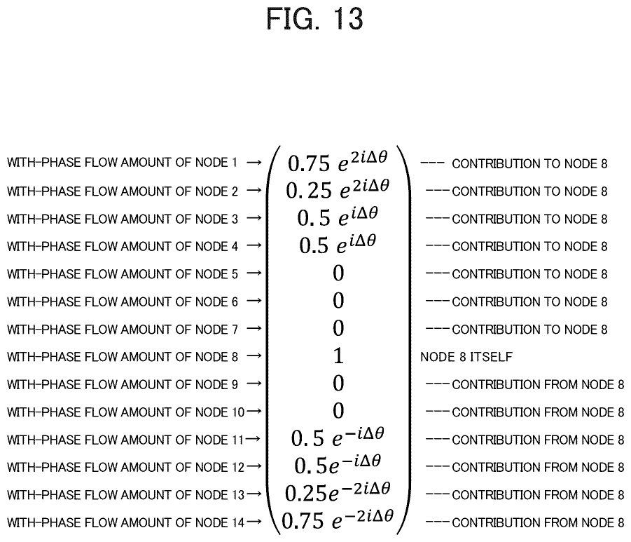

In Step S203, the vector obtaining unit 112 determines the vectorial representation of the vector-calculation target node in accordance with the trading subnetwork extracted in Step S202. The vector herein is, as will be described later on with reference to FIG. 13, a complex vector composed of elements each of which is a complex number having a size and a phase.

In Step S204, the vector obtaining unit 112 determines whether the vectorial representations of all the nodes included in the trading network have been determined. If there is a node whose vectorial representation has not yet been calculated (if NO in Step S204), the process goes back to Step S201 and continues. For instance, the vector obtaining unit 112 selects a node whose complex vector has not yet been calculated as a vector-calculation target node and determines the vectorial representation of this vector-calculation target node.

If the vectorial representations of all the nodes have been calculated (if YES in Step S204), the vector obtaining unit 112 ends the process shown in FIG. 7.

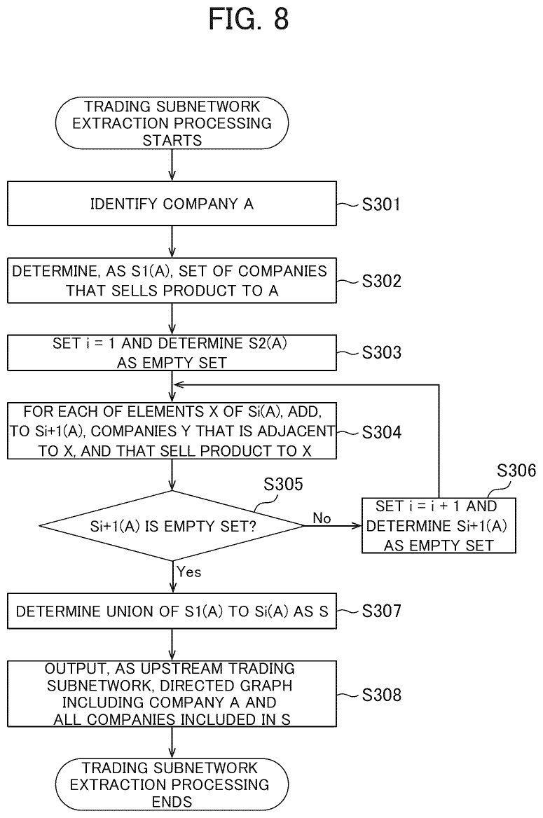

FIG. 8 is a flowchart showing a process for extracting a trading subnetwork, which corresponds to Step S202 in FIG. 7.

In Step S301, the vector obtaining unit 112 determines a specific company that is to be a basis for the extraction of a trading subnetwork. The specific company may be herein, for instance, a company corresponding to the vector-calculation target node selected in Step S202 in FIG. 7. For instance, a plurality of nodes included in the trading network are selected sequentially as vector-calculation target nodes, as shown in Steps S201 through S204 in FIG. 7. The specific company will be hereinafter referred to as a company A.

In Step S302, the vector obtaining unit 112 selects all companies X that are adjacent to the company A, corresponding to the vector-calculation target node, and sells something to the company A, and the vector obtaining unit 112 determines a set of the selected companies X as S1(A).

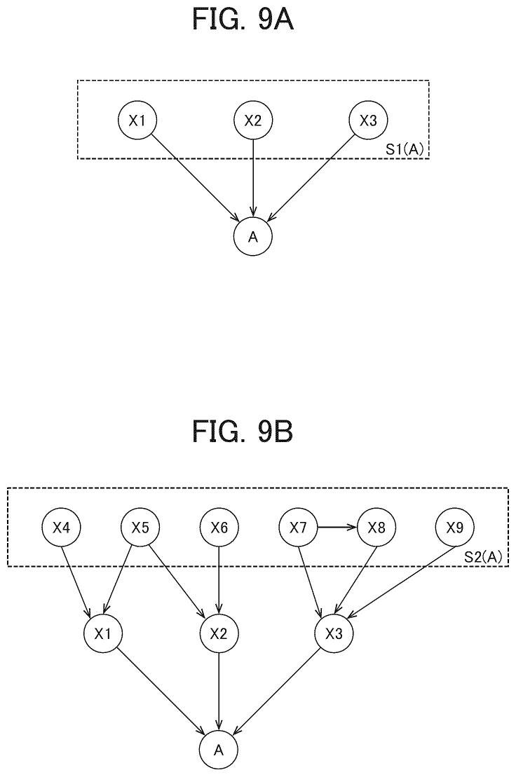

FIG. 9A illustrates S1(A) by way of example. For instance, FIG. 9A illustrates a trading network with a part including the company A being extracted. In the example in FIG. 9A, a node representing a company X1 is directly connected to a node representing the company A through an edge directed from X1 to A. That is, X1, which is a company that is adjacent to the company A and sells something to the company A, is determined as an element of S1(A). Likewise, X2 and X3, which are also companies that are adjacent to the company A and sell something to the company A, are determined as elements of S1(A). S1(A) in this case is a set of three elements X1, X2, and X3.

In Step S303, the vector obtaining unit 112 initializes a search variable i to 1 and determines Si+1(A) as an empty set. Here, i is initialized to 1, and Si+1(A) is thus S2(A). Accordingly, the vector obtaining unit 112 herein determines S2(A) as an empty set.

In Step S304, for each of the elements X of Si(A), the vector obtaining unit 112 adds, to Si+1(A), all companies Y that are adjacent to the element X and sell a product to the element X. When the processing in Step S304 is executed on a given company A for the first time, i=1 is established. Accordingly, in this case, for each of the elements X of S1(A), the vector obtaining unit 112 adds, to S2(A), all the companies Y that are adjacent to X and sell a product to X.

FIG. 9B illustrates S2(A) by way of example. S1(A) in this example is a set of three elements X1, X2, and X3, as earlier described with reference to FIG. 9A. The vector obtaining unit 112 firstly specifies a company Y that is adjacent to X1 and sells a product to X1. Here, two elements X4 and X5 satisfy this condition; thus, these two companies are added to S2(A). The vector obtaining unit 112 next specifies a company Y that is adjacent to X2 and sells a product to X2. Here, two elements X5 and X6 satisfy this condition. Since X5 has already been added to S2(A), X6 is added to S2(A). The vector obtaining unit 112 next specifies a company Y that is adjacent to X3 and sells a product to X3. Here, three elements X7, X8, and X9 satisfy this condition; thus, these three companies are added to S2(A). As a result, a set of six elements X4, X5, X6, X7, X8, and X9 is generated as S2(A) in Step S304, as illustrated in FIG. 9B for instance.

In Step S305, the vector obtaining unit 112 determines whether Si+1(A) is an empty set. In the example in FIG. 9B, S2(A), which contains six elements, is determined as not being an empty set (NO in Step S305). In this case, the vector obtaining unit 112 in Step S306 increments the variable i to initialize Si+1(A) to an empty set. The process then goes back to Step S304. For instance, the vector obtaining unit 112 determines S2(A), as illustrated in FIG. 9B, and then initializes S3(A) to an empty set in Step S306, followed by going back to the processing in Step S304.

In this case, the vector obtaining unit 112 in Step S304 specifies a company Y that is adjacent to a corresponding one of the elements X in S2(A) and sells a product to X, and the vector obtaining unit 112 adds the company Y to S3(A). For instance, the vector obtaining unit 112 specifies a company that is adjacent to X4 and sells a product to X4, and the vector obtaining unit 112 adds the specified company to S3(A). The same applies to X5 to X9; the vector obtaining unit 112 adds, to S3(A), a company that is adjacent to a corresponding one of the companies and sells a product to this company.

If S3(A) is not an empty set, the determination result in Step S305 is NO, and thus, the process goes back to Step S304 again and executes processing to determine S4(A). The succeeding processing is executed in a similar manner; until Si+1(A) becomes an empty set, the processing from Steps S304 through S306 is repeated.

That Si+1(A) is an empty set in Step S305 means that there is no element found that satisfies the condition as the result of the processing in Step S304. That is, none of the companies X, which are the elements of Si(A), has any more upstream company.

Thus, in this case (if YES in Step S305), the vector obtaining unit 112 in Step S307 determines a union of S1(A), S2(A), . . . , and Si(A) as S.

In Step S308, the vector obtaining unit 112 outputs, as a trading subnetwork, a directed graph including a node corresponding to the company A and nodes corresponding to all companies included in S. The trading subnetwork, which is herein a subnetwork representing upstream companies with reference to the company A, corresponding to the vector-calculation target node, is also referred to as an upstream trading subnetwork.

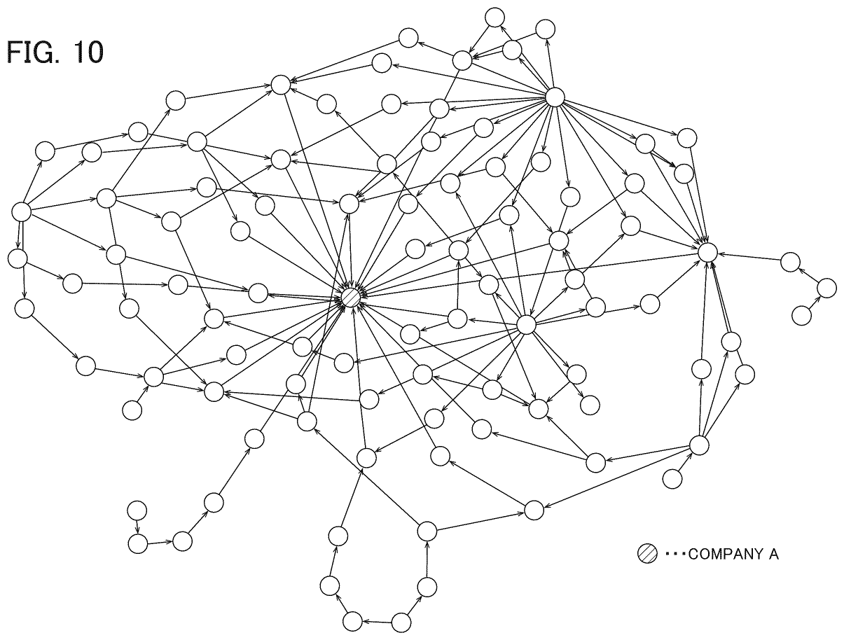

FIG. 10 illustrates an example of an upstream trading subnetwork. As illustrated in FIG. 10, the upstream trading subnetwork is a directed graph composed of nodes representing companies directly or indirectly connected to the company A. Doing so enables a portion related to a desired company to be extracted properly from the trading network. The upstream trading subnetwork, which constitutes information that enables specification of a relationship of connection between a company and the company A, is useful information for representing a feature of the company A by the use of a complex vector.

It is noted that in determining Si+1(A) in Step S304, the vector obtaining unit 112 may specify the company Y in accordance with a condition, “the company Y is not included in a union of {A}, S1(A), . . . , and Si(A)” in addition to the condition “the company Y is adjacent to and sells something to the element X of Si(A)”.

For instance, reference is made to a case in which three companies Xa, Xb, and Xc 5 exhibit a cycle of Xa←Xb←Xc←Xa, where Xa is an element of Si−2(A), Xb is an element of Si−1(A), and Xc is an element of Si(A). Here, “Xa←Xb” indicates that Xb is adjacent to and sells something to Xa. In this case, even though Xa is already an element of Si−2(A), Xa can be an element of Si+1(A) because it is adjacent to and sells something to Xc. That is, when the cycle is reflected as well, the processing that is executed by the vector obtaining unit 112 can become complicated. On that point, when the above condition “the company Y is not included in a union of {A}, S1(A), . . . , and Si(A)” is added, Xa is excluded from the elements of Si+1(A), thus enabling the processing to be simplified.

Further, in Step S305 in FIG. 8, the vector obtaining unit 112 may determine whether i≥k is established, in addition to whether Si+1(A) is an empty set. Herein, k is a value for determining the number of stages that undergo processing to extract a trading subnetwork. Although k is a value of, for instance, about three, a different value may be set. In response to the satisfaction of at least one of a first condition where Si+1(A) is an empty set, and a second condition where i≥k is established, the vector obtaining unit 112 may determine NO in Step S305 and may then end a further search. Doing so can limit the number of upstream stages in a trading subnetwork for determining a vectorial representation to k stages. Consequently, a company that is distant from a company corresponding to a vector-calculation target node can be excluded from the processing, thereby enabling load reduction in the processing. To be more specific, the number of elements whose values stand at 0 in their vectorial representations, which will be described later on, can be increased, thereby enabling calculation-load reduction in processing by the use of a complex vector (e.g., similarity calculation, and eigenvalue decomposition of the complex correlation matrix C).

It is noted that the foregoing has described an upstream trading subnetwork composed of upstream companies with reference to the company A. Nevertheless, a trading subnetwork shall not be limited to an upstream trading subnetwork; the trading subnetwork may include a downstream trading subnetwork. For the downstream trading subnetwork, the processing, which is similar to that in FIG. 8 with the exception that the search direction is changed, will not be described. For instance, the vector obtaining unit 112 extracts the trading subnetwork of a vector-calculation target node in a range including k stages upstream of the vector-calculation target node and k stages downstream of the same.

### 2.3.2 Processing to Determine Vectorial Representation

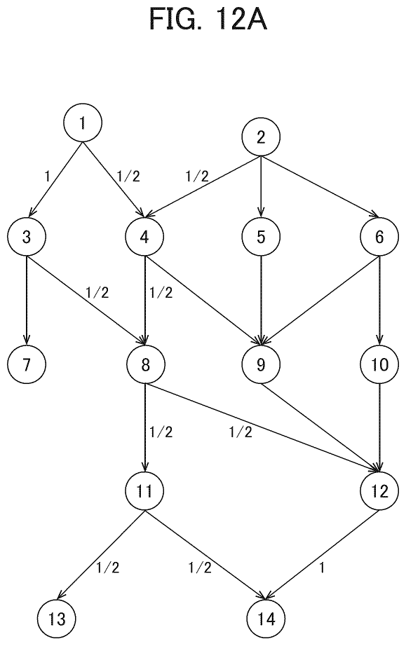

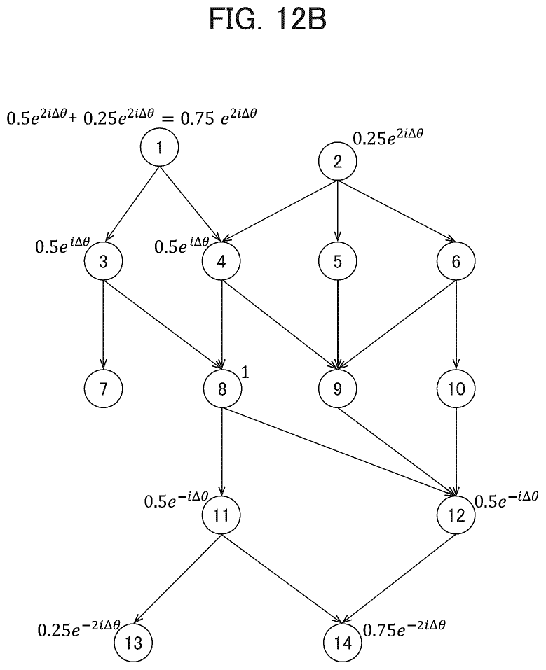

Processing to determine the vectorial representation of a vector-calculation target node in accordance with a trading subnetwork will be next described. In the technique in this embodiment, the vector obtaining unit 112 determines, for each of the nodes included in the trading subnetwork of a vector-calculation target node, a complex vector representing the vector-calculation target node by assigning a complex number having a phase corresponding to the distance to the vector-calculation target node, and having an absolute value corresponding to the amount of flow going to or coming from the vector-calculation target node. It is noted that the amount of flow in this embodiment is the amount of something that flows through a directed graph. The graph in this embodiment is a directed graph directed from upstream companies to downstream companies, and the amount of flow in this embodiment indicates the level of influence of the upstream companies that is exerted upon the downstream companies. As will be described later on with reference to FIG. 12A, the amount of flow in this embodiment may be information determined based on a connection relationship between nodes in a directed graph. Alternatively, the amount of flow may be information reflecting, for instance, a specific quantity of a product (including materials, raw materials, a manufacturing apparatus, and other things) that is supplied from an upstream company to a downstream company.

The technique in this embodiment enables the amount of flow in a directed graph, which is herein a trading network (in a narrow sense, a trading subnetwork), to be represented by the use of an absolute value and also enables the distance between nodes to be represented by the use of a phase. This enables a vectorial representation reflecting accurately the structure of a trading subnetwork (local graph) including a vector-calculation target node. To be more specific, as the vectorial representation of a node, information can be used that reflects in detail information including which of the upstream companies and which of the downstream companies the node is connected to.

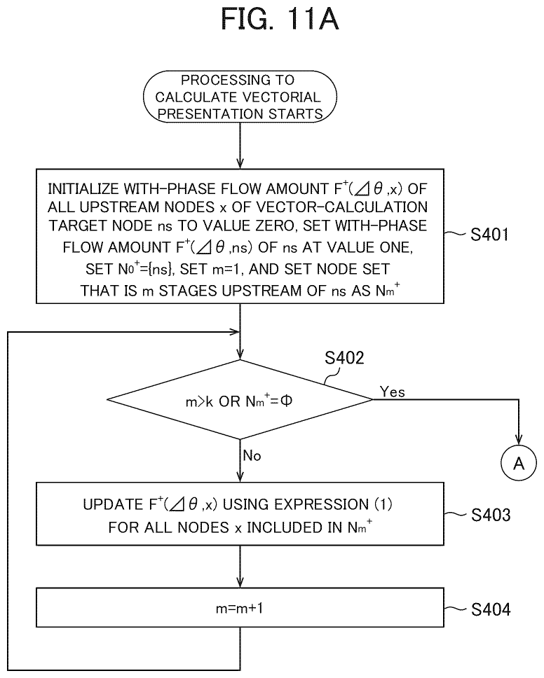

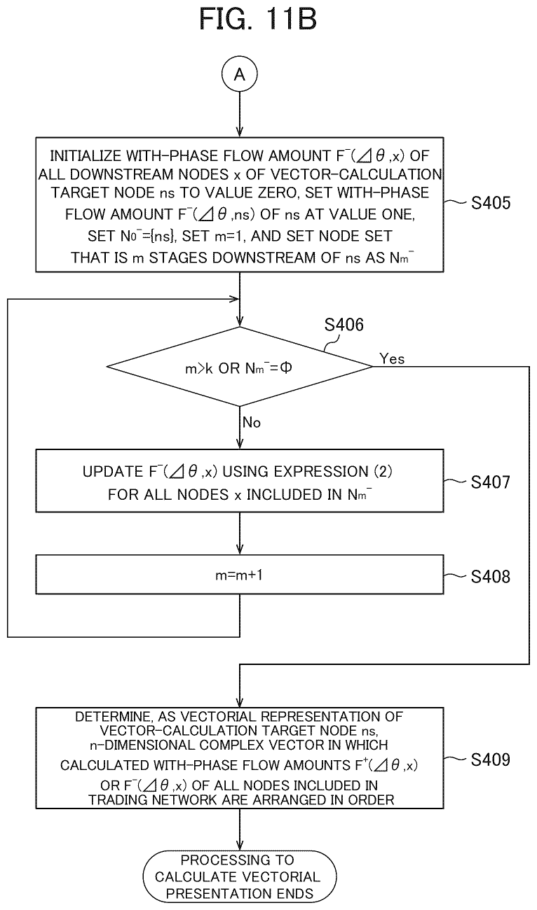

FIGS. 11A and 11B are flowcharts showing a process for determining the vectorial representation of a vector-calculation target node, which corresponds to Step S203 in FIG. 7. In Step S401, the vector obtaining unit 112 firstly executes initialization processing on an upstream node. In the following, let a node upstream of a vector-calculation target node ns be denoted as x; accordingly, the with-phase flow amount of the upstream node x is denoted as F⁺(Δθ, x). The vector obtaining unit 112 initializes F⁺(Δθ, x) to 0 for all upstream nodes x included in the trading network and located upstream of the vector-calculation target node ns. The vector obtaining unit 112 also sets F⁺(Δθ, ns), which is the with-phase flow amount of the vector-calculation target node ns itself, at 1. Further, let a node set that is m stages upstream of the vector-calculation target node be denoted as Nₘ⁺. A node that is zero stages away from the vector-calculation target node ns is the vector-calculation target node itself and is thus denoted as N₀⁺={ns}. The vector obtaining unit 112 also initializes m to 1.

In Step S402, the vector obtaining unit 112 determines whether at least one of m>k and Nₘ⁺=φ is satisfied. Herein, k is similar to, for instance, k described in the processing to extract the trading subnetwork and is a numeric value denoting the upper-limit number of stages in a search range. Further, e denotes an empty set.

If m≤k and Nₘ⁺≠φ are satisfied (if NO in Step S402), the vector obtaining unit 112 in Step S403 updates F⁺(Δθ, x) using Expression (1) below for all nodes x included in Nₘ⁺.

$$[ Equation 1 ]$$

$${F}^{+} ( Δθ , x ) = {F}^{+} ( Δθ , x ) + {e}^{i Δθ} \times \{ {\sum }_{all nodes y connected to x in {N}_{m - 1}^{+}} \{ ratio of distribution to edge connecting x and y \times {F}^{+} ( Δθ , y ) \} \} \qquad ( 1 )$$

Specific examples will be described with reference to FIGS. 12A and 12B. FIGS. 12A and 12B illustrate an instance where the trading network includes 14 nodes in total. Herein, let a node 8 be selected as a vector-calculation target node. It is noted that the trading network herein, which is small in scale and is identical to a trading subnetwork including three stages upstream of the node 8 and three stages downstream of the node 8, will not be distinguished from the trading subnetwork in the following description.

FIG. 12A illustrates the amount of flow in the trading network with a focus on the node 8. In this case, nodes that are one stage upstream of the node 8 are a node 3 and a node 4. That is, there are two edges for flow from a node one stage upstream of the node 8 into the node 8: one is the edge connecting the nodes 3 and 8 together, and the other is the edge connecting the nodes 4 and 8 together. Accordingly, when the amount of flow into the node 8 is set at 1, the amount of flow is distributed to the two edges at a given ratio.

For an equal distribution ratio for instance, the amount of flow from the node 3 into the node 8 stands at ½, and the amount of flow from the node 4 into the node 8 stands at ½. As a matter of course, when there are N (N is an integer equal to or greater than two) edges for flow from a node one stage upstream of the node 8 into the node 8, the amounts of flow corresponding to the respective edges stand at 1/N. The following describes an instance where the ratio of distribution stands at an equal ratio. It is noted that when a specific product trading volume or other things is associated with an edge, the ratio of distribution may be set based on this trading volume.

Once the ratio of distribution is determined, the calculation of Expression (1) above is performed specifically. For determining F⁺(Δθ, 3) for instance, F⁺(Δθ, 3) in the first term on the right-hand side before update is an initial value per se and thus stands at 0. Further, No is only the node 8, and thus, the “all nodes y connected to x in Nₘ₋₁⁺” is the node 8. Further, the ratio of distribution of the edge connecting the nodes 3 and 8 together stands at ½, as earlier described. Further, F⁺(Δθ, y) denotes the with-phase flow amount of a vector-calculation target node, which is herein the node 8, and thus stands at 1 as set in Step S401. Accordingly, F⁺(Δθ, 3) is updated as below. Likewise, F⁺(Δθ, 4) is updated as below.

$$\begin{matrix}{F}^{+} ( Δθ , 3 ) = 0 + {e}^{i Δθ} \times ( 1 / 2 ) \times 1 = 0.5 {e}^{i Δθ} \\ {F}^{+} ( Δθ , 4 ) = 0 + {e}^{i Δθ} \times ( 1 / 2 ) \times 1 = 0.5 {e}^{i Δθ}\end{matrix}$$

FIG. 12B illustrates an instance where a trading network similar to that in FIG. 12A is a target and illustrates, by way of example, the with-phase flow amount of each node with the node 8 selected as a vector-calculation target node. As earlier described, the with-phase flow amounts of the nodes 3 and 4 both stand at 0.5e^{iΔθ}.

In Step S404, the vector obtaining unit 112 next increments m and goes back to Step S402 to execute the processing. For instance, m=2 is set in the processing in Step S402 in the second time; thus, a determination on whether 2>k is satisfied, and a determination on whether N₂⁺ is an empty set are made.

When k=3 is established for instance, 2>k is not satisfied. Further, in the examples in FIGS. 12A and 12B, there are two nodes that are two stages upstream of the node 8: one is a node 1, which is one stage upstream of and adjacent to the node 3 and one stage upstream of and adjacent to the node 4; and the other is a node 2, which is one stage upstream of and adjacent to the node 4. That is, N₂⁺ is not an empty set, but a set of the nodes 1 and 2. Thus, the vector obtaining unit 112 in these examples determines NO in Step S402 and executes the processing in Step S403.

In this case, the nodes 1 and 2 included in N₂⁺ undergo update of their with-phase flow amounts. As illustrated in FIG. 12A, a node that is one stage upstream of the node 3 is only the node 1. That is, there is only one edge for flow from a node that is one stage upstream of the node 3 into the node 3: the edge connecting the nodes 1 and 3 together. Thus, the flow amount of the node 3 is a flow amount resulting, in its entirety, from the node 1, and its ratio of distribution stands at 1.

Further, there are two nodes that are one stage upstream of the node 4: the nodes 1 and 2. That is, there are two edges for flow from nodes that are one stage upstream of the node 4 into the node 4: one is the edge connecting the nodes 1 and 4 together, and the other is the edge connecting the nodes 2 and 4 together. Thus, the flow amount of the node 4, which is a flow amount resulting from the node 1 by half and resulting from the node 2 by the remaining half, has a distribution ratio of ½ for each half.

Once the ratio of distribution is determined, the calculation of Expression (1) above is performed specifically. For determining F⁺(Δθ, 1) for instance, F⁺(Δθ, 1) in the first term on the right-hand side before update is an initial value per se and thus stands at 0. Further, N₁⁺ is the nodes 3 and 4, both of which are connected to the node 1; thus, the “all nodes y connected to x in Nₘ₋₁⁺” are two nodes, i.e., the nodes 3 and 4. Further, the ratio of distribution of the edge connecting the nodes 1 and 3 together stands at 1, and the with-phase flow amount F⁺(Δθ, 3) of the node 3 stands at, as earlier described, 0.5e^{iΔθ}. Further, the ratio of distribution of the edge connecting the nodes 1 and 4 together stands at ½, and the with-phase flow amount F⁺(Δθ, 4) of the node 4 stands at, as earlier described, 0.5e^{iΔθ}. Accordingly, F⁺(Δθ, 1) is updated as below.

$${F}^{+} ( Δθ , 1 ) = 0 + {e}^{i Δθ} \times \{ 1 \times 0.5 {e}^{i Δθ} + 1 / 2 \times 0.5 {e}^{i Δθ} \} = 0 \text{.75} {e}^{2 i Δθ}$$

For determining F⁺(Δθ, 2), F⁺(Δθ, 2) in the first term on the right-hand side before update is an initial value per se and thus stands at 0. Further, N₁⁺ are the nodes 3 and 4, between which only the node 4 is connected to the node 2; thus, the “all nodes y connected to x in Nₘ₋₁⁺” is one node, i.e., the node 4. Further, the ratio of distribution of the edge connecting the nodes 2 and 4 together stands at ½, and the with-phase flow amount F⁺(Δθ, 4) of the node 4 stands at, as earlier described, 0.5e^{iΔθ}. Accordingly, F⁺(Δθ, 2) is updated as below.

$${F}^{+} ( Δθ , 2 ) = 0 + {e}^{i Δθ} \times \{ 1 / 2 \times 0.5 {e}^{i Δθ} \} = 025 e {2}^{i Δθ}$$

As can be seen from the above description, e^{iΔθ} undergoes multiplication every time the number of stages counted from the vector-calculation target node increases, and thus, the phase is shifted by Δθ every time. That is, in the technique in this embodiment, a node that is m stages upstream of a vector-calculation target node has a phase of mΔθ.

In Step S404, the vector obtaining unit 112 next increments m and goes back to Step S402 to execute the processing. For instance, m=3 is set in the processing in Step S402 in the third time; thus, a determination on whether 3>k is satisfied, and a determination on whether N₃⁺ is an empty set are made.

In the examples of the trading network in FIGS. 12A and 12B, there is no node that is upstream of the node 1 and is upstream of the node 2, and thus, N₃⁺ is an empty set. The vector obtaining unit 112 thus determines YES in Step S402 and proceeds to the processing on the downstream nodes shown in FIG. 11B. If N₃⁺ is not an empty set, and k≥3 is satisfied, the vector obtaining unit 112 determines NO in Step S402; accordingly, each of the nodes included in N₃⁺ undergoes update of its with-phase flow amount. That is, in the technique in this embodiment, the processing to update the with-phase flow amount is repeated toward upstream stages one by one until at least one of the following conditions is satisfied: k upstream stages have undergone the processing; and there is no more upstream node.

Upon completing the processing on the upstream nodes, the vector obtaining unit 112 in Step S405 in FIG. 11B executes initialization on downstream nodes. In the following, let a node downstream of the vector-calculation target node ns be denoted as x; accordingly, the with-phase flow amount of the downstream node x is denoted as F⁻(Δθ, x). The vector obtaining unit 112 initializes F⁻(Δθ, x) to 0 for all downstream nodes x included in the trading network and located downstream of the vector-calculation target node ns. The vector obtaining unit 112 also sets F⁻(Δθ, ns), which is the with-phase flow amount of the vector-calculation target node ns itself, at 1. Further, let a node set that is m stages downstream of the vector-calculation target node be denoted as Nₘ⁻. A node that is zero stages away from the vector-calculation target node ns is the vector-calculation target node itself and is thus denoted as N₀⁻={ns}. The vector obtaining unit 112 also initializes m to 1.

In Step S406, the vector obtaining unit 112 determines whether at least one of m>k and Nₘ⁻=φ is satisfied. That is, like the processing on the upstream nodes, the processing is repeated on the downstream nodes until the following condition is satisfied: k stages have undergone the processing, or there is no more downstream node.

If k stages have not yet undergone the processing, and there is a downstream node (if NO in Step S406), the vector obtaining unit 112 in Step S407 updates F⁻(Δθ, x) using Expression (2) below for all the nodes x included in Nₘ⁻.

$$[ Expression 2 ]$$

$${F}^{-} ( Δθ , x ) = {F}^{-} ( Δθ , x ) + {e}^{i - Δθ} \times \{ {\sum }_{all nodes y connected to x in {N}_{m - 1}^{-}} \{ ratio of distribution to edge connecting x and y \times {F}^{-} ( Δθ , y ) \} \} \qquad ( 2 )$$

In the example in FIG. 12A, nodes that are one stage downstream of the vector-calculation target node, i.e., the node 8, are a node 11 and a node 12. That is, there are two edges for flow from the node 8 into nodes that are one stage downstream of the node 8: one is the edge connecting the nodes 8 and 11 together, and the other is the edge connecting the nodes 8 and 12 together. Accordingly, when the amount of flow from the node 8 is set at 1, the amount of flow is distributed to the two edges at a given ratio. For an equal distribution ratio, the amount of flow from the node 8 to the node 11 stands at ½, and the amount of flow from the node 8 to the node 12 stands at ½.

Once the ratio of distribution is determined, the calculation of Expression (2) above is performed specifically. For determining F⁻(Δθ, 11) for instance, F⁻(Δθ, 11) in the first term on the right-hand side before update is an initial value per se and thus stands at 0. Further, N₀⁻ is only the node 8, and thus, the “all nodes y connected to x in Nₘ₋₁⁻” is the node 8. Further, the ratio of distribution of the edge connecting the nodes 8 and 11 together stands at ½, as earlier described. Further, F⁻(Δθ, y) denotes the with-phase flow amount of the vector-calculation target node, i.e., the node 8, and thus stands at 1 as set in Step S405. Accordingly, F⁻(Δθ, 11) is updated as below. Likewise, F⁻(Δθ, 12) is updated as below.

$$\begin{matrix}{F}^{-} ( Δθ , 11 ) = 0 + {e}^{- i Δθ} \times ( 1 / 2 ) \times 1 = 0.5 {e}^{- i Δθ} \\ {F}^{-} ( Δθ , 12 ) = 0 + {e}^{- i Δθ} \times ( 1 / 2 ) \times 1 = 0.5 {e}^{- i Δθ}\end{matrix}$$

In Step S408, the vector obtaining unit 112 next increments m and goes back to Step S406 to execute the processing. For instance, m=2 is set in the processing in Step S406 in the second time; thus, a determination on whether 2>k is satisfied, and a determination on whether N₂⁻ is an empty set are made.

In the examples in FIGS. 12A and 12B, the nodes 13 and 14 included in N₂⁻ undergo the processing to update F⁻(Δθ, 13) and F⁻(Δθ, 14). The detailed processing, which is similar to the example described earlier, will not be described. It is noted that e^{-iΔ0} undergoes multiplication every time the number of stages counted from the vector-calculation target node increases, and thus, the phase is shifted by −Δθ every time. That is, in the technique in this embodiment, a node that is m stages downstream of the vector-calculation target node has a phase of −mΔθ.

If at least one of the following conditions: k downstream stages have undergone the processing; and there is no more downstream node, is satisfied (if YES in Step S406), the vector obtaining unit 112 in Step S409 determines the vectorial representation of the vector-calculation target node in accordance with the with-phase flow amount determined for each of the nodes.

To be specific, the vector obtaining unit 112 determines, as the vectorial representation of the vector-calculation target node, an n-dimensional complex vector in which the with-phase flow amounts of all n nodes included in the trading network are arranged in a predetermined order.

FIG. 13 illustrates a vectorial representation in the examples described earlier with reference to FIGS. 12A and 12B. As earlier described, the trading network herein includes 14 nodes, and a determined vector is thus a 14-dimensional complex vector. For instance, the 14-dimensional complex vector is a vector in which the with-phase flow amounts of the nodes 1 to 14 are arranged in the stated order. It is noted that the order of a plurality of nodes included in the trading network is non-limiting; modifications can be made in various manners.

As earlier described, the nodes 1 to 4 and nodes 11 to 14, which are connected to the node 8 or a vector-calculation target node, undergo update of their with-phase flow amounts. Thus, the first to fourth elements and the eleventh to fourteenth elements are complex numbers that are not zero. In contrast, the nodes 5 to 7 and nodes 9 to 10 are not update targets, and thus, their with-phase flow amounts remain at an initial value, i.e., 0. Thus, the fifth to seventh elements and the ninth to tenth elements stand at 0. The eighth element, which is the with-phase flow amount of the node 8 itself, stands at 1.

The technique in this embodiment enables not only the use of a flow amount per se, but also the use of a vectorial representation reflecting the number of stages counted from a vector-calculation target node. In the example in FIG. 13, since the first element of the complex vector has a phase of 2Δθ, this complex vector can hold information indicating that the node 1 is two stages upstream of the vector-calculation target node. Likewise, since the third element has a phase of Δθ, the complex vector can hold information indicating that the node 3 is one stage upstream of the vector-calculation target node. By using the complex vector holding these information items in the subsequent processing, information including the number of stages is reflected to the processing, thereby enabling improvement in processing accuracy.

It is noted that in performing the processing on up to k upstream and downstream stages, the phases of a complex number constituting elements are Δθ, 2Δθ, 3Δθ, . . . , and kΔθ at the upstream stages and are −Δθ, −2Δθ, −3Δθ, . . . , and −kΔθ at the downstream stages. To clarify the relationship between phases and the number of stages, these phases do not desirably overlap each other. For instance, when k=3 is satisfied, setting Δθ=π/2 involves an overlap, such as e^{2iΔθ}=e^{-2iΔθ}=−1, thus making it difficult to distinguish, for instance, that a node is two stages upstream away from that the node is two stages downstream away. Accordingly, the value Δθ in this embodiment may be set based on k. For instance, Δθ is a positive real number satisfying (k+1)×Δθ=π.

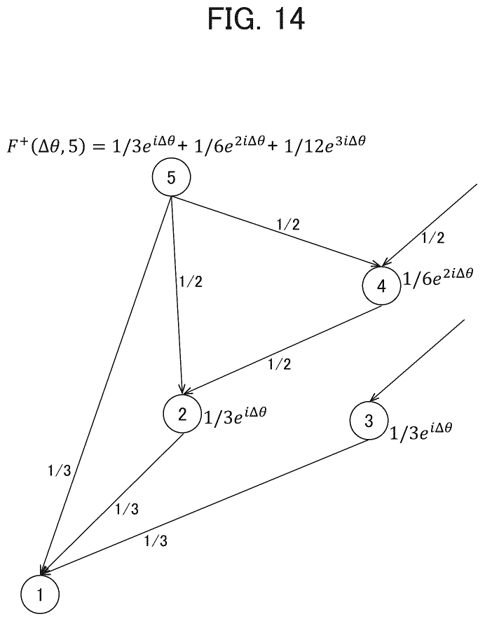

FIG. 14 illustrates part of a trading network of different structure. FIG. 14 shows an instance where the node 1 is selected as a vector-calculation target node, and where the with-phase flow amounts of the nodes 2 to 5 and other nodes are determined.

The node 5 herein, which is directly connected to the node 1, is a node included in N₁⁺. To be specific, the with-phase flow amount F⁺(Δθ, 5) of the node 5 is updated as below through processing targeted on N₁⁺.

$${F}^{+} ( Δθ , 5 ) = 0 + {e}^{i Δθ} \times ( 1 / 3 ) \times 1 = ( 1 / 3 ) {e}^{i Δθ}$$

The node 5, which is one stage upstream of the node 2 included in N₁⁺, is also a node included in N₂⁺. To be specific, the with-phase flow amount F⁺(Δθ, 5) of the node 5 is updated as below through processing targeted on N₂⁺. It is noted that the with-phase flow amount F⁺(Δθ, 2) of the node 2 is (⅓)e^{iΔθ}.

$${F}^{+} ( Δθ , 5 ) = ( 1 / 3 ) {e}^{i Δθ} + {e}^{i Δθ} \times ( 1 / 2 ) \times ( 1 / 3 ) {e}^{i Δθ} = ( 1 / 3 ) {e}^{i Δθ} + ( 1 / 6 ) {e}^{2 i Δθ}$$

Furthermore, the node 5, which is one stage upstream of the node 4 included in N₂⁺, is a node included in N₃⁺. To be specific, the with-phase flow amount F⁺(Δθ, 5) of the node 5 is updated as below through processing targeted on N₃⁺. It is noted that the with-phase flow amount F⁺(Δθ, 4) of the node 4 is (⅙)e^{2iΔθ}.

$${F}^{+} ( Δθ , 5 ) = ( 1 / 3 ) {e}^{i Δ θ} + ( 1 / 6 ) {e}^{2 i Δθ} + {e}^{i Δθ} \times ( 1 / 2 ) \times ( 1 / 6 ) {e}^{2 i Δθ} = ( 1 / 3 ) {e}^{i Δθ} + ( 1 / 6 ) {e}^{2 i Δθ} + ( 1 / 12 ) {e}^{3 i Δθ}$$

As described above, the technique in this embodiment can represent, by using the with-phase flow amount of a target node, a network structure in which there are multiple paths having different distances (the number of stages) measured from a vector-calculation target node to the target node. In the foregoing example for instance, F⁺(Δθ, 5) includes three phase terms, i.e., Δθ, 2Δθ, and 3Δθ; thus, the structure of the trading subnetwork illustrated in FIG. 14 is reflected appropriately to a vectorial representation.

The complex vector of each node in the trading network may be used in similarity calculation between the nodes for instance. For instance, the processing unit 110 may include a similarity calculating unit (not shown) that determines the similarity, S, between nodes i and j on the basis of Expression (3) below. In Expression (3) below, xⱼ* denotes a complex conjugate vector with conjugate complex numbers taken from individual elements of xⱼ. That is, the numerator on the right-hand side denotes the Hermitian inner product of xᵢ and xⱼ. Further, |xᵢ| and |xⱼ| respectively denote the sizes (norms) of xᵢ and xⱼ. R{ }denotes a real part.

$$[ Expression 3 ]$$

$$S = R \{ \frac{{x}_{i} \cdot {x}_{j}^{*}}{\vert {x}_{i} \vert \vert {x}_{j} \vert} \} \qquad ( 3 )$$

Doing so enables cosine similarity that is used in, for instance, similarity calculation between vectors, to be extended to a complex number. To be specific, a determination by the use of the distance (phase difference) between nodes can be made, as earlier described, thereby enabling similarity calculation with high accuracy.

### 2.4 Complex Correlation Matrix and Eigenvalue Decomposition

The complex vector according to this embodiment may be used in processing to extract a supply chain network from a trading network. To be specific, as shown in Step S103 in FIG. 4, the matrix obtaining unit 113 determines the complex correlation matrix C on the basis of the complex vector, and as shown in Step S104, the matrix obtaining unit 113 subjects the complex correlation matrix C to eigenvalue decomposition.

The matrix obtaining unit 113 firstly obtains the complex vectorial representation of each of first to n-th nodes included in the trading network. Hereinafter, a complex vector corresponding to the i-th (i is an integer satisfying 1≤i≤n) node will be denoted as xᵢ. For instance, the vector obtaining unit 112 selects each of the first to n-th nodes as vector-calculation target nodes and subjects them individually to the processing shown in FIGS. 11A and 11B to thus determine complex vectors x₁ to xₙ, and the vector obtaining unit 112 stores the determined x₁ to xₙ in the storage unit 120. Each of x₁ to xₙ is an n-dimensional complex vector; for instance, each is a column vector.

The matrix obtaining unit 113 next arranges x₁ to xₙ to obtain a matrix X. For instance, the matrix obtaining unit 113 obtains the matrix X=[x₁, x₂, . . . , xₙ], in which x₁ to xₙ are arranged in a predetermined order, and normalizes each component such that its absolute value stands at 1. The matrix obtaining unit 113 sets the matrix after the normalization anew as a matrix X. As described above, the processing of “arranging x₁ to x₁₈ to obtain a matrix X” in this embodiment is not limited to merely arranging x₁ to xₙ; this processing may include other kinds of processing (the processing may be pre-arrangement processing, or post-arrangement processing), such as normalization.

The matrix X is a square matrix of n rows and n columns. The matrix obtaining unit 113 also determines a matrix (complex conjugate transposition) X* in which conjugate complex numbers of the individual components of the matrix X are transposed. The matrix X* is a square matrix of n rows and n columns as well. It is noted that the order of arrangement of n nodes included in the trading network is the same as the order in determining the complex vector representations.

The matrix obtaining unit 113 then determines the complex correlation matrix C through C=XX*. The complex correlation matrix C is a square matrix of n rows and n columns as well. Each component of C corresponds to the Hermitian inner product of two complex vectors and is thus information corresponding to the similarity expressed by Expression (3) above. Thus, C can be used as the complex correlation matrix C indicating the node-to-node correlation between the first to n-th nodes in the trading network.

The matrix obtaining unit 113 next subjects the complex correlation matrix C to eigenvalue decomposition. To be specific, the matrix obtaining unit 113 decomposes, through C=VΛV⁻¹, the complex correlation matrix C into the following: a matrix V with its eigenvector as a column vector; and a diagonal matrix Λ with its eigenvalue as a diagonal component. Hereinafter, m eigenvalues will be denoted as e₁ to eₘ, and m eigenvectors corresponding to the respective eigenvalues will be denoted as v₁ to vₘ. Here, m is an integer satisfying m≤n. Since the eigenvalue decomposition is a publicly known method, its detailed description will be omitted.

It is noted that although the foregoing has described an instance where x₁ to xₙ are represented as column vectors, x₁ to xₙ may be represented as row vectors. In this case, for instance, the matrix obtaining unit 113 sets, as X, a matrix in which x₁ to xₙ are longitudinally arranged, and in which their absolute values are normalized to 1. Further, the matrix obtaining unit 113 may determine the complex correlation matrix C through C=X*X. As described above, the matrix obtaining unit 113 according to this embodiment performs processing to determine the complex correlation matrix C from a plurality of complex vectors, which represent respective nodes in a trading network, and processing to subject the complex correlation matrix C to eigenvalue decomposition. Their specific processing can be modified in various manners.

### 2.5 Obtainment of Supply Chain Network

Processing to extract a supply chain network, which corresponds to Step S105 in FIG. 4, will be next described.

The network extracting unit 114 performs processing to extract a supply-chain-network group in accordance a trading network and complex vectors, and processing to select a part of the supply-chain-network group including a reference node corresponding to an entity of interest, as a supply chain network that is a target for influence level calculation. Doing so enables an important part of the trading network to be extracted as a supply chain network and enables processing targeted on a specific node (company) to be performed. This can appropriately prevent the amount of information that is to be used in calculating a tag influence level.

Hereinafter, processing to extract a supply-chain-network group without company (node) limitations will be referred to as first extraction processing, and processing to extract a supply chain network from the supply-chain-network group with limitations on companies or other things will be referred to as second extraction processing.

### 2.5.1 Obtainment of Supply-Chain-Network Group

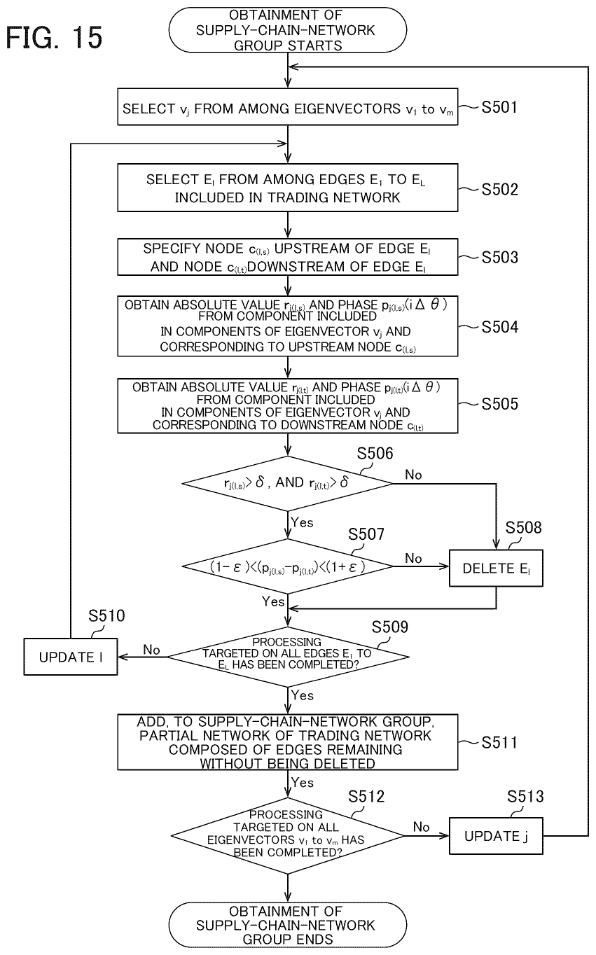

FIG. 15 is a flowchart showing the first extraction processing that is performed by the network extracting unit 114. In Step S501, the network extracting unit 114 firstly selects vⱼ from among m eigenvectors v₁ to vₘ. Here, j is an integer of 1 to m inclusive, and for example, its initial value is expressed as j=1.

Here, vⱼ, which is a vector obtained by subjecting the complex correlation matrix C of n rows and n columns to eigenvalue decomposition, is a column vector including n elements. For example, the eigenvector vⱼ is expressed as Expression (4) below. It is noted that for easy expression, Expression (4) below uses a transposition expression of the eigenvector vⱼ.

$$[ Expression 4 ]$$

$${v}_{j}^{T} = ( {r}_{j 1} {e}^{{p}_{j 1} ( i Δθ )} , {r}_{j 2} {e}^{{p}_{j 2} ( i Δθ )} , … , {r}_{jN} {e}^{{p}_{jN} ( i Δθ )} ) \qquad ( 4 )$$

Here, the first element of the eigenvector vⱼ indicates information about the node 1 in the trading network. That is, the node 1 has an absolute value (a flow amount) of rⱼ₁, and a phase (a distance from a reference node) of pⱼ₁. The same holds true for the second to n-th elements of the eigenvector vⱼ; each indicates the flow amount and phase of a corresponding one of the nodes 2 to n. That is, a single eigenvector is information for specifying the relationship (network structure) between n nodes included in the trading network. Moreover, in view that eigenvectors are determined from the complex correlation matrix C, a network structure represented by the eigenvectors is conceivably a main network structure in the trading network. As such, the network extracting unit 114 according to this embodiment performs the first extraction processing to extract the supply-chain-network group from the trading network in accordance with the eigenvectors.

In Step S502, the network extracting unit 114 selects Eₗ from among edges E₁ to E_{L} (L denotes the total number of edges and is an integer equal to or greater than two) included in the trading network. Here, l is an integer of 1 to L inclusive, and for example, its initial value is expressed as l=1.

In Step S503, the network extracting unit 114 specifies a node c_{(l, s)} upstream of the edge Eₗ and a node c_{(l, t)} downstream of the edge Eₗ. The edge Eₗ includes, for instance, the upstream node c_{(l, s)} and downstream node c_{(l, t)} as its attribute; by referring to these attribute values, the network extracting unit 114 performs the processing in Step S503.

In Step S504, the network extracting unit 114 determines the absolute value, r_{j(l, s)}, and phase, p_{j(l, s)}, of the upstream node c_{(l, s)} in accordance with the eigenvector vⱼ. To be specific, the network extracting unit 114 specifies in what position the upstream node c_{(l, s)} is placed among the nodes 1 to n included in the trading network, and the network extracting unit 114 reads a corresponding one of n elements of the eigenvector vⱼ to determine the absolute value r_{j(l, s)} and the phase p_{j(l, s)}. For example, when the upstream node c_{(l, s)} corresponds to the node 1, r_{j(l, s)}=rⱼ₁ is established, and p_{j(l, s)}=pⱼ₁ is established.

In Step S505, the network extracting unit 114 determines the absolute value, r_{j(l, t)}, and phase, p_{j(l, t)}, of the downstream node c_{(l, t)} in accordance with the eigenvector vⱼ. The specific processing is similar to that in the upstream node c_{(l, s)}.

The network extracting unit 114 then extracts the supply chain network by performing the following: first determination to determine the size of the flow amount of the upstream node c_{(l, s)}, and the size of the flow amount of the downstream node c_{(l, t)}, both of which are denoted by the absolute values of the elements of the eigenvector vⱼ; and second determination to determine the distance between the upstream node c_{(l, s)} and downstream node c_{(l, t)}, which is denoted by the phases of the elements of the eigenvector vⱼ. It is noted that both of the first determination and second determination are not essential; either one of them may be omitted.

In this way, the degree of importance of the edge Eₗ can be determined by the use of the flow amount and phase, both of which are determined from the eigenvector vⱼ. To be specific, when both of the flow amount of the upstream node c_{(l, s)} and the flow amount of the downstream node c_{(l, t)} are large to a certain extent in an eigenvector, the edge Eₗ connecting these two nodes together is presumably an important edge in the trading network. Further, the phase determined from the eigenvector vⱼ indicates the main connection relationship (distance, the number of stages) between the upstream node c_{(l, s)} and downstream node c_{(l, t)} in the network structure represented by this eigenvector vⱼ. That is, the importance of the edge Eₗ can be determined as being high if a connection relationship specified from the phase of an eigenvector, and the connection relationship in the edge Eₗ are close to each other, and the importance of the edge Eₗ can be determined as being low if these relationships are far from each other. As described above, using a flow amount and a phase can make an appropriate determination on the edge Eₗ.

In Step S506, the network extracting unit 114 performs the first determination based on the flow amount. To be specific, the network extracting unit 114 determines whether the absolute value r_{j(l, s)} of the upstream node c_{(l, s)} is greater than a given threshold δ, and whether the absolute value r_{j(l, t)} of the downstream node c_{(l, t)} is greater than the given threshold δ.

If both of r_{j(l, s)} and r_{j(l, t)} are greater than δ (if YES in Step S506), the network extracting unit 114 in Step S507 performs the second determination based on the phase (distance). To be specific, the network extracting unit 114 subtracts the phase p_{j(l, t)} of the downstream node c_{(l, t)} from the phase p_{j(l, s)} of the upstream node c_{(l, s)} and determines whether the subtracted value is greater than 1−ε and smaller than 1+ε. Here, ε denotes a given threshold.

The numeral value 1 included in 1+ε and 1−ε is a value denoting the distance between two adjacent nodes. As described above, the upstream node c_{(l, s)} and downstream node c_{(l, t)} in the trading network are two nodes directly connected together by the edge Eₗ, and their node-to-node distance stands at 1. That is, when the edge Eₗ is important in the trading network, it is presumed that the upstream node c_{(l, s)} and downstream node c_{(l, t)} are directly connected together by an edge corresponding to the edge Eₗ, that is, their node-to-node distance, determined from the eigenvector vⱼ, stands at a value that is sufficiently close to 1, even in a network structure represented by the eigenvector vⱼ. On the other hand, when the edge Eₗ is not important in the trading network, it is presumed, in the network structure represented by the eigenvector vⱼ, that the upstream node c_{(l, s)} and downstream node c_{(l, t)} are not connected together in the first place, or that their node-to-node distance stands at a value that is different from 1 as the result of their connection through an edge that is different from the edge Eₗ.

As such, in Step S507, the network extracting unit 114 determines a difference value between the distance between the upstream node c_{(l, s)} and downstream node c_{(l, t)} determined from the eigenvector vⱼ, and the distance (to be specific, 1) between two adjacent nodes. Accordingly, the importance of the edge Eₗ can be appropriately determined based on the phase.

If at least one of the flow amounts is equal to or smaller than the threshold δ (if NO in Step S506), or if the absolute value of the difference between the distance and the numeral value 1 is equal to or greater than F (if NO in Step S507), the importance of the edge Eₗ, which is a processing target, is determined as being low. Accordingly, in Step S508, the network extracting unit 114 performs processing to exclude Eₗ from the supply chain network, which is an extraction target.

On the other hand, if both of the flow amounts are greater than the threshold δ (if YES in Step 506), and if the absolute value of the difference between the distance and the value 1 is smaller than F (if YES in Step 507), the edge Eₗ is left as an edge constituting the supply chain network.

The processing targeted on the edge Eₗ is thus completed. In Step S509, the network extracting unit 114 determines whether the processing targeted on all the edges E₁ to E_{L} included in the trading network has been completed.

If there is an unprocessed edge (if NO in Step S509), the network extracting unit 114 in Step S510 updates the variable l and then goes back to Step S502. For instance, the network extracting unit 114 subjects the edge E₁ to the processing, followed by incrementing the variable l to update 1 to 2, followed by subjecting the edge E₂ to the foregoing processing in Steps S502 to S509.

If the processing targeted on all the edges has been completed (if YES in Step S509), the network extracting unit 114 in Step S511 adds a network composed of some of the edges E₁ to E_{L} remaining without being excluded in the processing in Step S508, to the supply-chain-network group. The network added herein is a partial network of the trading network. It is noted that the network composed of some of the edges E₁ to E_{L} remaining without being excluded in the processing in Step S508 does not necessarily constitute a graph in which all nodes are connected together; this network may be divided into several networks. The network extracting unit 114 in this case performs processing to add such individual divided networks to the supply-chain-network group.

Through the processing in Steps S501 to S511, the extraction of the supply chain network targeted on the eigenvector vⱼ is completed. In Step S512, the network extracting unit 114 next determines whether the processing targeted on all the eigenvectors v₁ to vₘ determined through eigenvalue decomposition has been completed.

If there is an unprocessed eigenvector (if NO in Step S512), the network extracting unit 114 in Step S513 updates the variable j and then goes back to Step S501. For instance, the network extracting unit 114 subjects the eigenvector v₁ to the processing, followed by incrementing the variable j to update j to 2, followed by subjecting the eigenvector v₂ to the foregoing processing in Steps S502 to S513. It is noted that when an eigenvector that is to be processed undergoes update, the processing result in Step S508 undergoes initialization as well, and the processing in Step S502 is started again with all of the edges E₁ to E_{L} unremoved.

If the processing targeted on all the eigenvectors has been completed (if YES in Step S512), the network extracting unit 114 ends the first extraction processing to extract the supply-chain-network group. That is, the supply-chain-network group is a set of partial networks determined for the respective eigenvectors v₁ to vₘ.

### 2.5.2 Selection of Supply Chain Network

The network extracting unit 114 next performs the second extraction processing to extract a supply chain network related to a particular company from the supply-chain-network group. For instance, the network extracting unit 114 extracts a supply chain network including a node corresponding to a given company from the supply-chain-network group determined through the first extraction processing shown in FIG. 15. Here, the given company may be input using the operation unit 250 of the terminal device 200. For instance, the user of the terminal device 200 performs an operation to select a company of interest that requires some kind of analysis, such as his/her company itself, a competitor, or a company to be bought out. The network extracting unit 114 performs the second extraction processing by specifying a node corresponding to the selected company, and extracting a network including the specified node from among the networks included in the supply-chain-network group.

Further, the network extracting unit 114 may narrow down supply chain networks on the basis of another condition. For instance, the network extracting unit 114 may select a supply chain network related to a particular product of the company of interest. The network extracting unit 114 in this case may determine whether information indicating the selected product is included in a tag provided to an edge in the supply-chain-network group.

### 2.6 Calculation of Influence Level

The processing in the influence-level calculating unit 115 will be next described. The following describes an instance where, as earlier described, the information processing system 10 includes the network extracting unit 114 that extracts, as the second network 122, a part of the first network 121 composed of nodes whose distances from a reference node are equal to or smaller than a given threshold. For instance, the foregoing supply chain network is a network including a node whose distance from a reference node corresponding to an entity of interest is equal to or smaller than k. The influence-level calculating unit 115 in this case may determine the influence level in the second network 122. With the second network 122 as a target, an important part of the first network 121 can undergo influence level calculation. The influence level in an essential trading relationship of the entity of interest can be determined when the second network 122 is a supply chain network. How to calculate the influence level will be described below by the use of a specific supply chain network.

### 2.6.1 Weight of Path

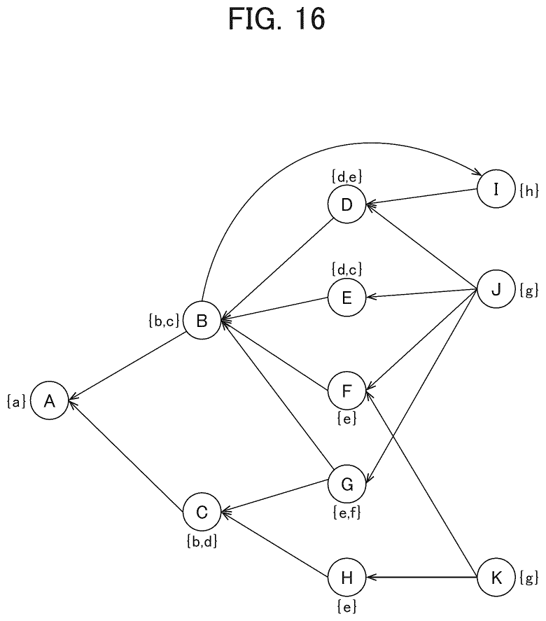

FIG. 16 illustrates an example of a supply chain network that is the second network 122 to be subjected to influence level calculation. The following describes a supply chain network of simple configuration including 11 nodes A to K. In FIG. 16, the tags provided to the individual nodes are illustrated with the symbol { }. The lower-case alphabets a to h denote tag value (attribute value) examples included in the tags; here, a single alphabet denotes a single industrial classification. For instance, the node A is associated with the alphabet a as an industrial classification. Further, a single company runs multiple business enterprises in some cases. As such, a single node may be associated with a plurality of industrial classifications. For instance, the node B is associated with the alphabets b and c as industrial classifications. The same holds true for the nodes C to K, each of which is provided with a tag including one or more industrial classifications.

The supply chain network illustrated in FIG. 16 has a path A→B→D→I, the order of which is the inverse of the arrows on the drawing sheet. Hereinafter, a path on which a plurality of nodes are connected together will be simply represented by a row of alphabets denoting nodes. For instance, a path ABDI represents a path passing through the nodes A, B, D, and I in the stated order. The supply chain network in FIG. 16 has an edge directed from the node B to the node I and thus has a path IB, the order of which is the inverse of the arrow on the drawing sheet. The supply chain network hence includes an infinite loop ABDIBDIB . . . .

When such a loop is included in the second network 122, the loop may be removed before the influence-level calculating unit 115 calculates the influence level. For instance, the information processing system 10 may include a network updating unit (not shown in FIG. 2) that updates the second network 122 by removing a loop included in the second network 122. The network updating unit is included in, for instance, the processing unit 110 of the server system 100. To be specific, the network updating unit eliminates the edge between the nodes I and B, constituting a loop, with the path ABDI immediately before a loop being reflected. This can prevent the calculation load in the influence level calculation. When focusing on the flow of goods, based on findings that a loop appearing in a supply chain network does not have to be considered as an essential part (e.g., Kichikawa, Y, Iyetomi, H., Iino, T. et al. Community structure based on circular flow in a large-scale transaction network. Appl Netw Sci 4, 92 (2019). https://doi.org/10.1007/s41109-019-0202-8), it is possible to execute appropriate processing even if a loop is removed.

Although the foregoing has described an instance where the second network 122 undergoes processing, the first network 121 may undergo the influence level calculation as described above. A loop can be removed in this case as well. For instance, when the first network 121 includes a loop, the network updating unit may update the first network 121 by removing the loop.

FIG. 17 illustrates the supply chain network in FIG. 16 with the loop removed and with the weight at each edge added. For instance, in the supply chain network in FIG. 17, the node A is a downstream end, and the nodes I, J, and K are upstream ends.

There is one path of transition from the node A to the node I: ABDI. There are five paths of transition from the node A to the node J: ABDJ, ABEJ, ABFJ, ABGJ, and ACGJ. There are two paths of transition from the node A to the node K: ABFK, and ACHK. As such, the supply chain network illustrated in FIG. 17 has eight paths.

The influence-level calculating unit 115 determines the weight of each of these paths. FIG. 18 is a table showing examples of a weight based on the structure of the supply chain network, that is, examples of a path weight determined based on a flow amount. Let the flow amount of the node A be set at 1 for instance; in this case, the node A is connected to the nodes B and C. When the flow amount is divided into equal amounts, the flow amount of the node B stands at 0.5, which is a half of the flow amount of the node A, i.e., 1. Likewise, the flow amount of the node C also stands at 0.5.

Further, the node B is connected to the node D, node E, node F, and node G. Thus, the flow amount of the node B, i.e., 0.5 is distributed to these four nodes. Accordingly, the flow amount of each node stands at 0.5×(¼)=0.125.

Further, the node D is connected to the node I and node J. Thus, the flow amount of the node D, i.e., 0.125 is distributed to these two nodes. Accordingly, the weight (flow amount) at the end node I along a node transition, i.e., the path ABDI, stands at 0.125×(½)=0.0625. The influence-level calculating unit 115 sets the weight at the terminal node of the path as the weight of the path. Likewise, the weight of the end node J along the path ABDJ stands at 0.0625, and thus, the weight of the path ABDJ stands at 0.0625 as well.

The same holds true for the other paths. For instance, the node E is connected to only the node J, and thus, the weight of the path ABEJ stands at 0.125, which is the same as the flow amount at the node E. The node F is connected to the node J and node K, and thus, the weight of the path ABFJ and the weight of the path ABFK each stand at 0.0625. The node G is connected to only the node J, and thus, the weight of the path ABGJ stands at 0.125, which is the same as the flow amount at the node G in the case of passing through the node B. In addition, the weight of the path ACGJ stands at 0.25, which is the same as the flow amount at the node G in the case of passing through the node C. The node H is connected to only the node J, and thus, the weight of the path ACHK stands at 0.25, which is the same as the flow amount at the node H. FIG. 18, the column “WEIGHT AT END NODE ALONG NODE TRANSITION” compiles these weights.

### 2.6.2 Weight of Tag Transition Pattern

After determining the weight of a path, the influence-level calculating unit 115 determines the weight of a tag transition pattern by distributing this path weight in accordance with the number of tag transition patterns. Specific processing will be described below.

Reference is made to the path ABDI in the supply chain network in FIG. 17. The node A is associated with the alphabet a, which is a tag value denoting an industrial classification. The node B is associated with the alphabets b and c as tag values. The node D is associated with the alphabets d and e as tag values. The node I is associated with the alphabet h as a tag value.

That is, there are four possible transition patterns: abdh, abeh, acdh, and aceh, each denoting how the tag value changes along the path ABDI. It is noted that abdh denotes a tag transition pattern in which the tag values a, b, d, and h, provided to respective four nodes, appear in the stated order in the case of a transition of these four nodes. The same holds true for the other examples. That is, referring to the path ABDI, the number of tag values provided to the respective nodes is 1, 2, 2, and 1; thus, there are four possible tag transition patterns (i.e., 1×2×2×1=4) along the path ABDI.

The same holds true for the other paths. The number of tag transition patterns along each path is the following: four patterns along the path ABDJ; four patterns along the path ABEJ; two patterns along the path ABFJ; two patterns along the path ABFK; four patterns along the path ABGJ; four patterns along the path ACGJ; and two patterns along the path ACHK. FIG. 18, the column “NUMBER OF POSSIBLE TAG TRANSITIONS” exhibits the number of tag transition patterns.

The influence-level calculating unit 115 determines the weight of each of the foregoing 26 transition patterns (#1 through #26 in FIG. 18) determined from these eight paths. For instance, the influence-level calculating unit 115 determines the weight of each tag transition pattern by dividing the weight of a corresponding one of the paths equally to the tag transition patterns along the path. For instance, there are four possible tag transition patterns along the path ABDI: abdh, abeh, acdh, and aceh, as earlier described. Moreover, the weight of the path ABDI stands at 0.0625, as earlier described. The influence-level calculating unit 115 in this case quarters 0.0625 equally to assign a weight of 0.015625 to each of abdh, abeh, acdh, and aceh, corresponding to respective tag transition patterns #1 to #4. Likewise, referring to each of #5 through #26, the influence-level calculating unit 115 determines the weight of each tag transition pattern by dividing the weight of a corresponding one of the paths equally in accordance with the number of tag transition patterns. FIG. 18, the column “WEIGHT PROVIDED TO EACH TAG TRANSITION” compiles the determined weights of the tag transition patterns.

Here, FIG. 18 shows an instance where the nodes D and E are both associated with the alphabet d as their attribute. Thus, with regard to nodes, the path ABDJ and the path ABEJ are different paths, whereas with regard to tags, an identical transition pattern, i.e., abdg, conceivably appears in the path ABDJ and path ABEJ in some cases (this corresponds to #5 and #9 in FIG. 18). In this embodiment, it is allowed that an identical tag transition pattern appears in duplicate when the weight of a tag transition pattern is determined in the foregoing manner. For instance, the influence-level calculating unit 115 may separately process information about #5: the tag transition pattern abdg and the weight 0.015625, and information about #9: the tag transition pattern abdg and the weight 0.03125. The following describes this instance. It is noted that the influence-level calculating unit 115 may perform processing that will be described below, after integrating the information about #5 and #9 into one piece of information: the tag transition pattern abdg and the weight 0.015625+0.03125=0.046875; the specific processing can be modified in various manners.

As shown in FIG. 18, the influence-level calculating unit 115 may set a tier denoting the distance from a reference node. Here, the node A, which is one end of the supply chain network, is defined as a reference node. The node A is a node corresponding to, for instance, an entity selected as an entity of interest (company of interest) by the user of the terminal device 200. Tier P (P is an integer) denotes a node whose distance from the reference node stands at P. Referring to the path ABDJ, Tier 1 corresponds to the node B, Tier 2 corresponds to the node D, and Tier 3 corresponds to the node I. The same holds true for the other paths.

Further, a tier may be associated with not only a node on a path, but also a tag value provided to the node. Referring to #1 for instance, i.e., the tag transition pattern abdh, the alphabet a, which is the tag of the node A, corresponds to Tier 0. Likewise, the alphabet b, which is the tag of the node B, corresponds to Tier 1; moreover, the alphabet d, which is the tag of the node D, corresponds to Tier 2; moreover, the alphabet h, which is the tag of the node I, corresponds to Tier 3. The same holds true for tag transition patterns #2 to #26. As such, the influence-level calculating unit 115 determines the tag value of each tier with regard to each tag transition pattern. FIG. 18, the columns Tier 0 to Tier 3 compiles the tag values of the individual tiers.

### 2.6.3 Reception of Selection Condition and Calculation of Influence Level

The influence-level calculating unit 115 next receives an input of a given selection condition including at least a designated tag value. The input is herein performed in the terminal device 200 for instance. For instance, when a tag is information indicating an industrial classification, the selection condition may be a condition for specifying any one of a plurality of tag values as the designated tag value. The influence-level calculating unit 115 calculates the influence level by selecting a tag transition pattern matching the selection condition from among a plurality of tag transition patterns.

For instance, upon receiving the selection condition including a first industrial classification as the designated tag value, the influence-level calculating unit 115 calculates the influence level of the first industrial classification in accordance with the weight of the tag transition pattern including a tag value corresponding to the first industrial classification. Doing so enables appropriate calculation of an index indicating how much a particular industrial classification influences an entity of interest in a supply chain network.

Reference is made to an instance where, for instance, the alphabet c, which herein denotes an industrial classification, is input as a designated tag value. The influence-level calculating unit 115 in this case selects a tag transition pattern including c from among all the tag transition patterns denoted as #1 to #26 in FIG. 18.

FIGS. 19A and 19B are tables showing selected tag transition patterns. FIG. 19A is a table showing tag transition patterns whose tag values in Tier 1 stand at c. In the example in FIG. 18, 10 tag transition patterns corresponding to #3, #4, #7, #8, #11, #12, #14, #16, #19, and #20 include c as their tag values in Tier 1. Moreover, each tag transition pattern is provided with a weight, as earlier described. The influence-level calculating unit 115 calculates the influence level of the industrial classification c in Tier 1 by determining the sum of the weights of, for instance, the 10 tag transition patterns shown in FIG. 19A. In the example in FIG. 19A, the industrial classification c in Tier 1 has an influence level of 0.25.

FIG. 19B is a table showing tag transition patterns whose tag values in Tier 2 stand at c. In the example in FIG. 18, two tag transition patterns corresponding to #10 and #12 include c as their tag values in Tier 2. The influence-level calculating unit 115 calculates the influence level of the industrial classification c in Tier 2 by determining the sum of the weights of, for instance, the two tag transition patterns shown in FIG. 19B. In the example in FIG. 19B, the industrial classification c in Tier 2 has an influence level of 0.0625.

In the example in FIG. 18, the industrial classification c does not appear in Tier 3. Thus, the influence-level calculating unit 115 determines the industrial classification c in Tier 3 as having a zero influence.

Based on the foregoing processing, the influence-level calculating unit 115 determines that the industrial classification c in the supply chain network illustrated in FIG. 17 has an influence level of 0.3125 (i.e., 0.25+0.0625+0=0.3125).

Further, the influence-level calculating unit 115 may determine the influence level of an industrial classification other than the foregoing. For instance, the user of the terminal device 200 may input a request for determining the influence level of each industrial classification. The influence-level calculating unit 115 in this case may calculate the influence level of each industrial classification by individually selecting industrial classifications b to h sequentially as a designated tag value. It is noted that although the tag value a of the node A, corresponding to an entity of interest, is omitted herein, the influence level of the industrial classification a may be calculated.

FIG. 20 is a table showing calculation results of the influence level of each industrial classification calculated for each tier. How to calculate the influence level, which is similar to the example described earlier with reference to the industrial classification c, will not be elaborated upon. For instance, the influence-level calculating unit 115 calculates, for each industrial classification, the sum of the influence levels in Tiers 1 through 3 (corresponding to the column “TOTAL” in FIG. 20) as the influence level of the industrial classification.

### 2.7 Treemap Generation

Processing in the treemap generating unit 116, which corresponds to Step S107 in FIG. 4, will be next described. The treemap generating unit 116 generates a treemap with an arrangement of figures each having an area corresponding to the influence level calculated by the influence-level calculating unit 115. Doing so enables information about a processing target network (in a narrow sense, a supply chain network that is the second network 122) to be presented in such a manner that its overview can be grasped easily. For instance, determining the influence level for each of a plurality of tag values enables a dominantly influential tag value or a large-and-small relationship in influence level between tag values to be presented in an easy-to-understand manner.

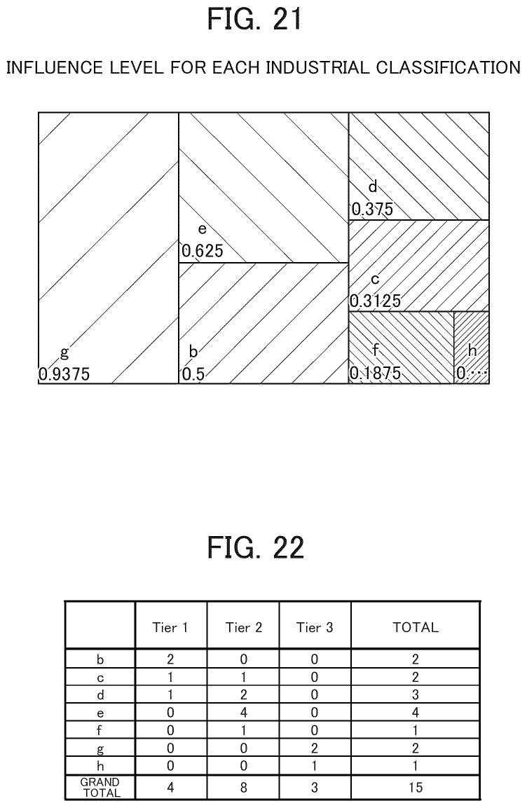

FIG. 21 illustrates a treemap example generated by the treemap generating unit 116 and being based on the influence levels shown in FIG. 20. As shown in the rightmost column in FIG. 20, in this example, an influence level value is determined for each of the industrial classifications b to h. Accordingly, the treemap generating unit 116 generates a treemap to display figures (in a narrow sense, quadrangles) establishing a large-and-small relationship based on the influence level values while associating these figures with the respective industrial classifications.

The information processing system 10 has a display processing unit (not shown in FIG. 2) that controls the display unit 240 of the terminal device 200 to display the treemap in FIG. 21. Doing so allows the user of the terminal device 200 to understand that, for instance, the industrial classification g has a very large influence level in the supply chain network of the entity of interest.

It is noted that nodes provided with the industrial classification g are the nodes J and K, which constitute the endpoints of the supply chain network illustrated in FIG. 17. As can be seen from this example, the technique in this embodiment can assess, but not limited to, a tag provided to a node located at the endpoint of a network. Betweenness centrality has been conventionally used as an index for determining the importance (choke-point likelihood) of a node within a network. However, betweenness centrality is calculated for nodes located in the middle of a path; at the endpoint of a network, the value of betweenness centrality stands at zero. In contrast to this, this embodiment enables, as described above, the influence level even with regard to a node (in a narrow sense, a tag associated with the node) located at the endpoint of a network to be calculated appropriately.

Further, the treemap generating unit 116 in the technique in this embodiment may generate a treemap based on other information in addition to the treemap based on the influence levels. For instance, FIG. 22 is a table showing results in which a frequency at which each of the industrial classifications b to h appears in the supply chain network in FIG. 17 is compiled for each tier. For instance, the industrial classification b appears once at each of the nodes B and C, which fall under Tier 1; thus, its frequency in Tier 1 stands at 2. In addition, Tiers 2 and 3 include no node provided with the industrial classification b; thus, the frequency of the industrial classification b in both Tiers 2 and 3 stands at 0. Further, the column “TOTAL” in FIG. 22 shows the sum total of the frequencies in Tier 1 through Tier 3. This frequency count processing may be executed by the influence-level calculating unit 115 for instance, or another constituents (e.g., a frequency calculating unit, which is not shown in FIG. 2) of the processing unit 110.

For the industrial classifications c to h as well, the results shown in FIG. 22 are obtained by counting appearance frequencies in the supply chain network illustrated in FIG. 17. For instance, the treemap generating unit 116 may generate a treemap based on the appearance frequencies.

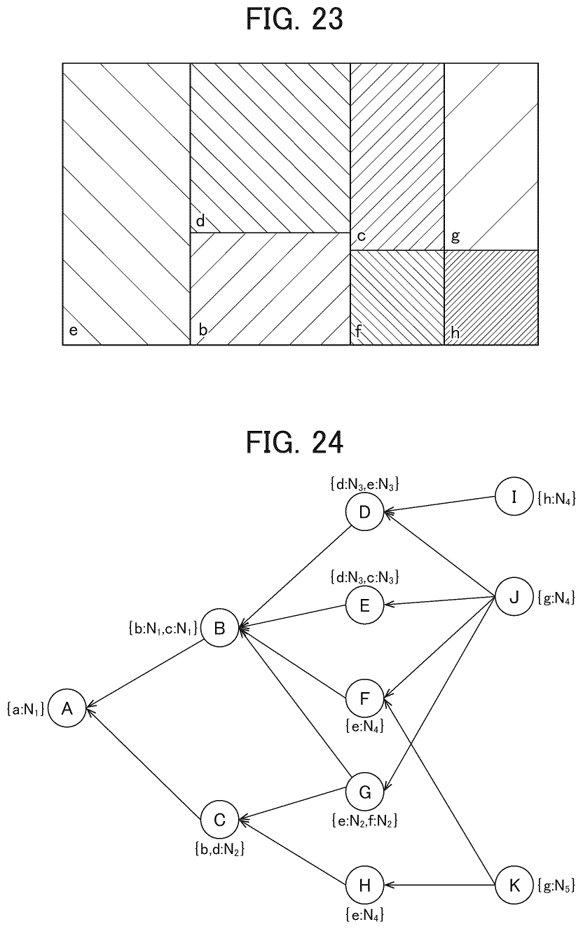

FIG. 23 illustrates a treemap example generated by the treemap generating unit 116 and is based on the frequencies shown in FIG. 22. The comparison between FIGS. 21 and 23 reveals that although the industrial classification g is dominant in the influence level according to this embodiment (FIG. 21), the industrial classification g has a relatively small area in this frequency-based treemap (FIG. 23). Other than the foregoing, there are significant differences between the influence-level-based treemap and the frequency-based treemap. That is, using the influence level according to this embodiment can obtain information that cannot be obtained by the mere use of frequencies.

Moreover, the display processing unit according to this embodiment may perform processing to display the influence-level-based treemap and the frequency-based treemap in a comparable manner. These two treemaps may be displayed next to each other on the display unit 240 of the terminal device 200, for instance; alternatively, switching from one of the treemaps to the other may be possible.

For instance, the user who has simply viewed only the influence-level-based treemap (FIG. 21) merely understands that the industrial classification g has a large influence level. On the other hand, displaying the influence-level-based treemap together with the frequency-based treemap (FIG. 23) allows the user to understand that although having a low appearance frequency, the industrial classification g has a very large influence level in the supply chain network. This corresponds to, but not limited to, an instance where the industrial classification g is applied to an industry for supplying an essential primary raw material in the supply chain network of an entity of interest.

For instance, even when the user has found out that there is an industrial classification having a high appearance frequency and a large influence level in a certain network, this finding is a mere reasonable result, and there is a possibility that the finding is not so important as information. On the other hand, when the user has found out that there is an industrial classification having a low appearance frequency and a large influence level, this means that information has been obtained that is difficult to find out through conventional analysis without using the influence level according to this embodiment. That is, using a treemap based on the influence level together with a treemap based on an index other than the influence level allows the user to judge the usefulness of information obtained from this influence-level-based treemap.

### 3. Modifications

Some modifications will be described below.

### 3.1 Other Examples of Selection Condition

### 3.1.1 Combination of Multiple Attributes

The foregoing has described processing to determine the influence level on the basis of, by way of example, a tag value representing an industrial classification (industrial classifications b to h). It is noted the tag in this embodiment is not limited to information indicating a single kind of attribute; the tag may be information in which a plurality of attributes are combined together. In this case, information in which the attribute value of a first attribute and the attribute value of a second attribute are combined together is provided as a tag value to each node in the first network 121 and second network 122.

The tag may be herein, for instance, information for specifying a combination of an industrial classification and a country. FIG. 24 illustrates an example of a supply chain network in which each node is provided with a tag representing a combination of an industrial classification and a country. The alphabets a to h in FIG. 24 are each attribute values for specifying industrial classifications, like those earlier described. In addition, N1 to N5 are attribute values representing countries or regions to which entities corresponding to the nodes belong.

For instance, an entity corresponding to the node A is a company belonging to a country N1 and categorized into the industrial classification a. In addition, an entity corresponding to the node B is a company belonging to the country N1 and categorized into the industrial classification b. With regard to the nodes C to K as well, a single tag value is similarly represented by a combination of an industrial classification and a country in the example in FIG. 24.

The influence-level calculating unit 115 subjects the supply chain network in FIG. 24 to influence level calculation. There is no change in the processing to determine a path weight even when the tag value changes. Accordingly, for each of the paths ABDI, ABDJ, ABEJ, ABFJ, ABFK, ABGJ, ACGJ and ACHK, the influence-level calculating unit 115 calculates the weight of an end node as the weight of the path, like the examples in FIG. 17.

The influence-level calculating unit 115 next performs processing to determine a tag transition pattern and distribute the weight of the path in accordance with the number of tag transition patterns. For instance, the path ABDI has four tag transition patterns listed below.
(a:N1)(b:N1)(d:N3)(h:N4)
(a:N1)(b:N1)(e:N3)(h:N4)
(a:N1)(c:N1)(d:N3)(h:N4)
(a:N1)(c:N1)(e:N3)(h:N4)

Accordingly, the influence-level calculating unit 115 sets the weight of each of these four tag transition patterns at 0.015625, which is determined by equally quartering the weight of the path ABDI, i.e., 0.0625.

The same holds true for the other paths and tag transition patterns. That is, the influence-level calculating unit 115 calculates the weights of these tag transition patterns through processing similar to the processing described earlier with reference to FIG. 18, with the exception that the tag values in each of the columns, Tier 0 to Tier 3, shown in FIG. 18 are extended to combinations of an industrial classification and a country.

Moreover, upon receiving a selection condition including a combination of a first industrial classification and a first country as a designated tag value, the influence-level calculating unit 115 calculates the influence level exerted by the first industrial classification of the first country in accordance with the weight of a tag transition pattern including a tag value corresponding to the combination of the first industrial classification and first country. Doing so enables the influence level to be calculated appropriately even when the tag values are extended to combinations of a plurality of attributes. This can assess an influence exerted upon the network of an entity of interest by a more complicated event.

For instance, in the network illustrated in FIG. 17, the industrial classification b can be selected as a designated tag. In this case, the value 0.5 is calculated as the influence level of the industrial classification b (FIG. 20). In the network illustrated in FIG. 24 by contrast, a plurality of designated tag values, i.e., (b:N1) and (b:N2), can be selected in designation including the industrial classification b. The influence-level calculating unit 115 performs processing to sum the weights of tag transition patterns including (b:N1) in response to the selection of (b:N1) as a designated tag value, and processing to sum the weights of tag transition patterns including (b:N2) in response to the selection of (b:N2) as a designated tag value. In the example in FIG. 24, (b:N1) has an influence level of 0.25, and (b:N2) has an influence level of 0.25. The same holds true for instances where designated tag values other than the foregoing are input as a selection condition.

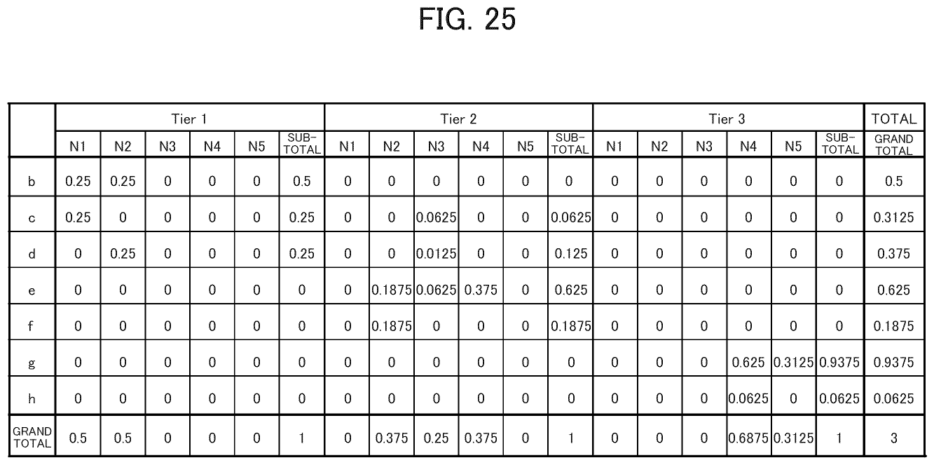

FIG. 25 is a table showing the results of an influence level calculation for each industrial classification, each country, and each tier. In FIG. 25, the influence levels of the combinations of the industrial classification and country are listed in cells of the intersections between rows denoting industrial classifications and columns denoting countries. For instance, for each combination of an industrial classification and a country, the influence-level calculating unit 115 calculates the sum of the influence levels in Tiers 1 to 3 as the influence level of the combination of the industrial classification and country.

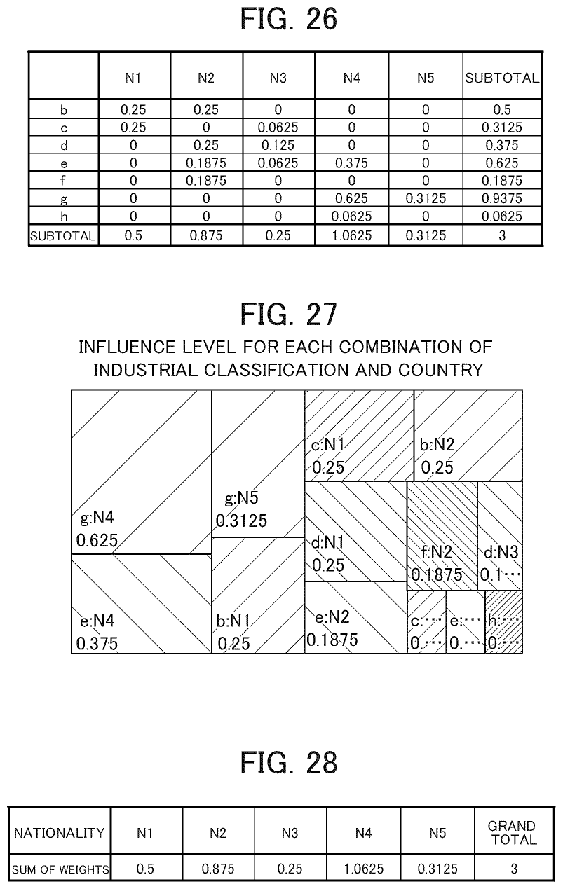

FIG. 26 is a table showing the influence levels of combinations of an industrial classification and a country obtained by summing the values in each tier. The table here addresses seven industrial classifications and five countries, and thus, the influence level is calculated for each of 35 tag values. Reference is made to an instance where, for instance, only industrial classifications are reflected. Although the industrial classification b has an influence level of 0.5 (FIG. 20), the table reveals that reflecting a combination with a country as well offers further detailed information that the industrial classification b of the country N1 and the industrial classification b of a country N2 each have an influence level of 0.25.

FIG. 27 illustrates a treemap example generated based on the influence levels shown in FIG. 26. The display processing unit of the information processing system 10 may control the display unit 240 of the terminal device 200 to display the treemap illustrated in FIG. 27. Doing so allows the user of the terminal device 200 to understand that, for instance, the industrial classification g of a country N4 has a very large influence level in the supply chain network of an entity of interest. Consequently, a more detailed influence level for each country can be presented to the user in an easy-to-understand manner than that in the treemap in FIG. 21. It is noted that the display unit 240 may display an influence-level-based treemap and a frequency-based treemap in a comparable manner, as earlier described with reference to FIG. 21.

It is also noted that for instance, the sum (corresponding to the column “SUBTOTAL” at the rightmost end of the table) of the influence levels listed in the individual cells in a row of the table in FIG. 26 denotes the influence level of an industrial classification that is not based on a country. Moreover, the influence levels of industrial classifications that are not based on countries coincide with the values listed in the column “TOTAL” in FIG. 20. Thus, the influence-level calculating unit 115 may determine the influence level of each industrial classification by performing processing to determine the influence level for each tag value, which is a combination of an industrial classification and a country, and to then sum a plurality of influence levels whose industrial classifications are common (sum a plurality of influence levels that are different in only country). In this case as well, the influence-level calculating unit 115 can obtain results similar to those described earlier with reference to FIGS. 16 to 21.

In a broader sense, the influence-level calculating unit 115 may perform processing to determine the influence level for each tag value, which is a combination of the attribute value of a first attribute and the attribute value of a second attribute, and then sum a plurality of influence levels that are common in the first attribute and different in the second attribute, to thus delete the second attribute. Doing so enables the influence level to be calculated easily in both of a case where the combination of the first attribute and second attribute is designated as a selection condition, and a case where only the first attribute is designated as a selection condition. As a matter of course, the influence-level calculating unit 115 may perform processing to delete the first attribute in response to the designation of only the second attribute as a selection condition.

As described above, an attribute to be deleted can be selected in any manner; hence, an industrial classification may be deleted from a combination of the industrial classification and a country. For instance, the sum (corresponding to the column “SUBTOTAL” at the lowermost end of the table) of the influence levels listed in the individual cells in a column of the table in FIG. 26 denotes the influence level of a country that is not based on an industrial classification.

FIG. 28 is a table showing the influence level for each country. For instance, the treemap generating unit 116 according to this embodiment may generate a treemap based on the influence levels shown in FIG. 28. As described above, a tag in this embodiment is information indicating a country; upon receiving a selection condition including a first country as a designated tag value, the influence-level calculating unit 115 may calculate the influence level of the first country in accordance with the weight of a tag transition pattern including a tag value corresponding to the first country. It is noted that as can be seen from the above description, a tag value may be limited to information indicating a country from the time point of determining the weight of a tag transition pattern; alternatively, processing to use a tag transition pattern including a country and other information and finally delete an attribute other than the country may be performed. Both of these processes are included in the foregoing processing to “calculate the influence level of the first country in accordance with the weight of a tag transition pattern including a tag value corresponding to the first country”.

### 3.1.2 Company ID

A tag in this embodiment is not limited to an industrial classification and/or a country. For instance, the tag may be information indicating a company corresponding to a node. This can assess the influence level at which a designated company influences the network of an entity of interest.

In the supply chain network illustrated in FIG. 17 for instance, the node A is provided with a tag A as a company ID, and the node B is provided with a tag B as a company ID. The same holds true for the nodes C to K. Since the nodes correspond one-to-one to the company IDs in this example, the path ABDI thus has a single tag transition pattern ABDI. The same holds true for the other paths. It is noted that a company provided with Q (Q is any one of A to K) as a company ID will be hereinafter referred to as a company Q.

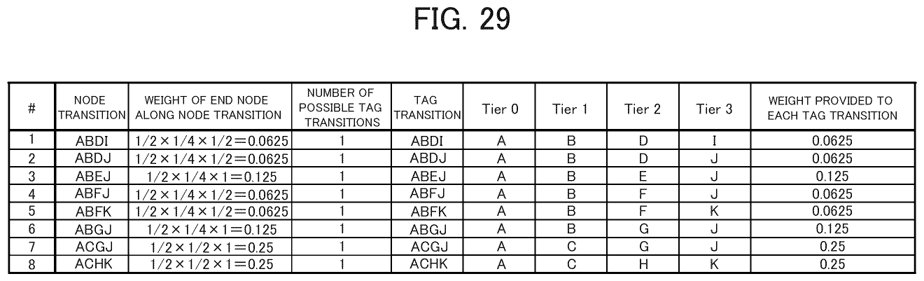

FIG. 29 is a table showing the weights of paths and the weights of tag transition patterns. As earlier described, each of the eight paths has a single tag transition pattern. There are thus eight tag transition patterns, and their weights coincide with the weights of the respective paths. The columns Tier 0 to Tier 3 in FIG. 29 show tag values, each of which denotes a company ID corresponding to a node.

The influence-level calculating unit 115 in this case may receive an input of a single company ID and calculate the influence level of the company ID. Reference is made to an instance where B is designated as a company ID. In this case, there are six tag transition patterns including B as a tag value: #1 to #6; thus, the company B has an influence level of 0.5. The influence levels of the companies C to K can be determined similarly.

It is noted that a selection condition is not limited to the foregoing; a selection condition including a plurality of company IDs may be input. For instance, the influence-level calculating unit 115 receives an input to designate a first company of interest, a second company of interest, and a third company of interest. It is noted that the processing here is performed on an entity of interest (corresponding to a reference node, for instance, the node A in FIG. 18) as a criterion; hence, any one of the plurality of company IDs included in the selection condition may correspond to this entity of interest. For instance, the first company of interest is an entity of interest. When an entity of interest is input in specifying a processing target network, the input of the first company of interest may be omitted in inputting the selection condition.

Moreover, the influence-level calculating unit 115 calculates the influence level at which the third company of interest influences the first company of interest via the second company of interest, in accordance with the weight of a tag transition pattern in which the tag value of the second company of interest is between the tag value corresponding to the first company of interest and the tag value corresponding to the third company of interest. Doing so enables not only the influence level of an individual company alone, but also the influence level exerted via another company to be determined appropriately.

Reference is made to an instance where, for instance, the first company of interest is the company A, the second company of interest is the company B, and the third company of interest is the company J. In this case, the influence-level calculating unit 115 selects a pattern in which A, B, and J appear in the stated order from among the tag transition patterns. It is noted that A and B in a pair, and B and J in a pair do not necessarily have to be adjoined to each other; another company ID may be interposed between them.

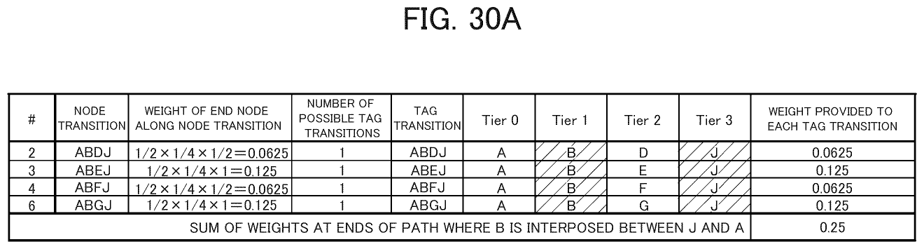

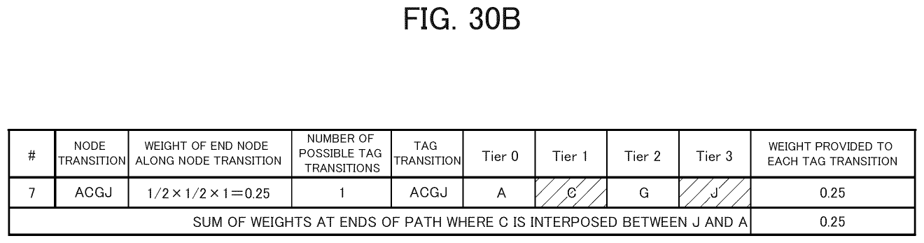

FIG. 30A is a table showing examples of a tag transition pattern selected upon an input of A, B, and J as a selection condition. A, B, and J appear in the stated order in four tag transition patterns #2, #3, #4, and #6 among #1 to #8 in FIG. 29. Since the weights of the individual tag transition patterns are already known, the influence-level calculating unit 115 determines the influence level at which the company J influences the company A, which is an entity of interest, via the company B by adding the weights of these four tag transition patterns.

FIG. 30B is a table showing an example of a tag transition pattern selected upon an input of A, C, and J as a selection condition. A, C, and J appear in the stated order in only tag transition pattern #7 among #1 to #8 in FIG. 29. The influence-level calculating unit 115 thus calculates the weight of this tag transition pattern as 0.25, as the influence level at which the company J influences the company A, which is an entity of interest, via the company C.

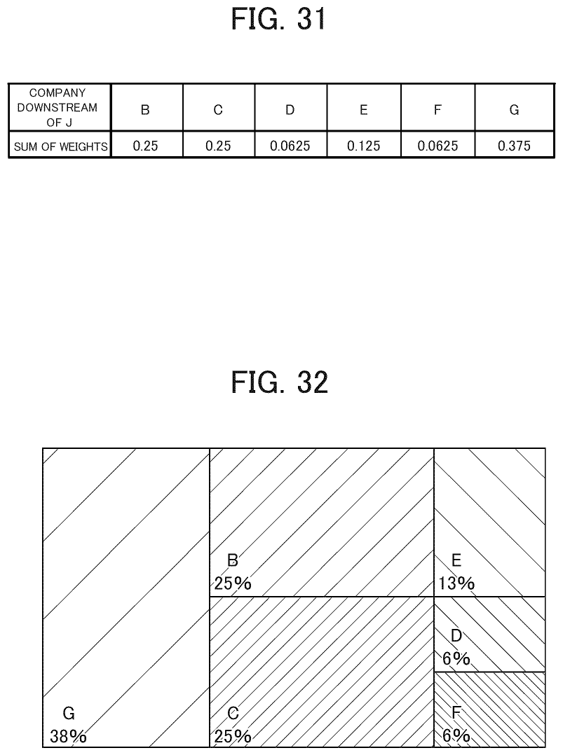

FIG. 31 is a table showing results obtained by performing similar processing individually on the companies D to G. Doing so enables a determination on in which case the influence level is large among those where the companies B to G are interposed, in assessing the influence level at which the company J influences the company A.

FIG. 32 illustrates a treemap example generated based on the influence levels shown in FIG. 31. Showing the treemap in FIG. 32 can present a company that is important when the company J influences the company A to the user of the terminal device 200 in an easy-to-understand manner.

The foregoing has described, by way of example, receiving a selection condition including a plurality of attribute values (tag values) when an attribute is a company ID. When a tag is information indicating an industrial classification for instance, a selection condition including a plurality of industrial classifications may be input. For instance, inputting a selection condition including the industrial classifications a, b, and g can determine the influence level at which the industrial classification g influences, via the industrial classification b, the industrial classification a to which an entity of interest belongs. As a matter of course, similar processing may be performed with regard to any attribute.

### 3.1.3 Combination of Tag Value and Distance (Tier)

The influence-level calculating unit 115 may also receive an input of a selection condition to select a designated tag value and the distance from a reference node. The influence-level calculating unit 115 in this case determines the influence level of a tag value at a predetermined distance from an entity corresponding to the reference node in accordance with the weight of a tag transition pattern in which the designated tag value is included in a location specified by distance. This can calculate the influence level reflecting how far a node is away from the reference node (entity of interest).

For instance, FIG. 20 shows seven industrial classifications and three distances, i.e., Tiers 1 to 3; accordingly, 21 influence level values are determined. The foregoing has described an instance where the sum of the values in the individual tiers (the column “TOTAL” in FIG. 20) constitutes the influence level of each industrial classification; here, processing using the 21 influence level values separately may be performed. For instance, a treemap is generated with the influence level, i.e., 0.25, of the industrial classification c in Tier 1 and the influence level, i.e., 0.0625, of the industrial classification c in Tier 2 regarded as mutually different information pieces.

In a treemap generated in such a manner, information corresponding to the distance from an entity of interest, for instance, is presented, thereby allowing the user to assess, in more detail, at which distance from the entity of interest the influence level of a certain industrial classification becomes large. Alternatively, the influence-level calculating unit 115 may extract only the influence level at equal to or greater than a predetermined distance from the entity of interest. This allows the user to grasp the influence level of, for instance, a company having no direct trading relationship with the entity of interest.

### 3.2 Other Network Examples

The foregoing has described an instance where the first network 121 is a trading network, and the second network 122 is a supply chain network. It is noted these networks according to this embodiment are not limited to the foregoing.

For instance, the first network 121 may be a shareholding network in which a plurality of nodes corresponding one-to-one to a plurality of entities are connected together by edges each representing a control relationship determined by a shareholding ratio. The influence-level calculating unit 115 may subject the whole shareholding network to processing or subject an extracted part (second network 122) of the shareholding network to processing.

FIG. 33 illustrates a shareholding network example. FIG. 33 shows a shareholding network of simple configuration including eight nodes A to H. A company corresponding to a node V (V is any one of A to H) will be denoted as a company V. FIG. 33 omits tags provided to the individual nodes. Further, the numeric values written along the edges denote the shareholding ratios between the companies. Here, a company at the proximal end of each arrow holds stocks of a company at the distal end of the arrow. For instance, the companies B, C, and D hold stocks of the company A, and their shareholding ratios stand at the following: the company B, 40%; the company C, 30%; and the company D, 30%. The same holds true for the other edges.

In the case as well where the first network 121 is a shareholding network, the influence-level calculating unit 115 firstly performs processing to determine the weight of a path. The weight of a path is the weight of the end node on each path, as earlier described. In a shareholding network, each edge is associated with a shareholding ratio, as illustrated in FIG. 33. The influence-level calculating unit 115 may thus determine the weight of the end node on the basis of the shareholding ratio.

For instance, the influence-level calculating unit 115 determines the weight of the end node on the basis of the product of the shareholding ratios along the path. The example in FIG. 33 shows six possible paths ABE, ABF, ACF, ADCF, ADG, and ADH. As such, the weight of the node E on the path ABE is calculated as 0.4×0.95=0.38 on the basis of a shareholding ratio of 0.4, provided to the edge between A and B, and a shareholding ratio of 0.95, provided to the edge between B and E. That is, the path ABE has a weight of 0.38.

The weights of the other paths are also calculated as below.

$$\begin{matrix}ABF : 0.4 \times 0.05 = 0.02 \\ ACF : 0.3 \times 1. = 0.3 \\ ADCF : 0.3 \times 0.51 \times 1. = 0.153 \\ ADG : 0.3 \times 0.3 = 0.09 \\ ADH : 0.3 \times 0.09 = 0.027\end{matrix}$$

As described, the weights of the paths are determined. The subsequent processing is similar to that described above. To be specific, the influence-level calculating unit 115 determines the weight of a tag transition pattern by determining the tag transition pattern in accordance with tags provided to the nodes A to H, and by distributing the weight of the path. The influence-level calculating unit 115 further calculates the influence level in accordance with the weight of the tag transition pattern selected based on a selection condition including a designated tag value. The attribute included in each tag may be an industrial classification, a country, another attribute, or a combination of a plurality of attributes.

Further, each tag may be information indicating a company ID. Let F (the company ID of a company corresponding to the node F) be selected as a designated tag value in the shareholding network in FIG. 33. In this case, the weight of a tag transition pattern is equal to the weight of a path; here, three paths ABF, ACF, and ADCF include the company F. The influence-level calculating unit 115 can thus calculate the influence level of the company F as 0.02+0.3+0.153=0.473, which is the sum of the weights of these three paths. This value is equal to the indirect shareholding ratio of the company F to the company A. That is, using the technique according to this embodiment and using a company ID as a tag can determine the indirect shareholding ratio of each company within a network.

Further, each tag may be information indicating the category of an entity corresponding to a node. The category is herein information indicating the organizational structure of an entity and may include, as tag values, at least two or more of an individual, a business company, an investment company, a public agency, and a stock holding association. In this case, upon receiving a selection condition including a first category as a designated tag value, the influence-level calculating unit 115 calculates the influence level of an entity belonging to the first category in accordance with the weight of a tag transition pattern including the tag values corresponding to the first category. This can assess what kind of entity categories can exert a stock-based controlling power upon an entity of interest. It is noted that a tag representing a category may be used when a trading network or a supply chain network is a target.

Further, the processing to determine the weight of a path (the weight of an end node) in a shareholding network is not limited to the foregoing. Reference is made to an instance where a controlling node has an over 50% shareholding ratio to a controlled node. The influence-level calculating unit 115 in this case may replace a value that is multiplied in passing through their edge with the value 1 and replace a value that is multiplied in passing through an edge directed from the controlled node to another controlling node with the value 0.

Let the node B be a controlled node; accordingly, the nodes E and F are controlling nodes. Moreover, the edge between B and E is provided with a shareholding ratio of 0.95, which is greater than 0.5; thus, this value is replaced with 1. On the other hand, the value provided to the edge directed to the node F, which is connected similarly to the controlled node B, is replaced from 0.05 to 0. Accordingly, the weight of the path ABE is calculated as 0.4×1.0=0.4, and the weight of the path ABF is calculated as 0.4×0=0.

Likewise, let the node D be a controlled node; in this case, the edge between D and C is provided with a shareholding ratio of 0.51, which is greater than 0.5. Accordingly, the influence-level calculating unit 115 replaces the value provided to this edge with 1 and replaces the values provided to the edges between D and G and between D and H with 0. As such, the weights of the other paths are calculated as below.

$$\begin{matrix}ACF : 0.3 \times 1. = 0.3 \\ ADCF : 0.3 \times 1. \times 1. = 0.3 \\ ADG : 0.3 \times 0 = 0 \\ DH : 0.3 \times 0 = 0\end{matrix}$$

The subsequent processing in this case is also similar to that described above. In addition, the attribute included in a tag can be modified in various manners, as earlier described. For instance, the attribute may be, but not limited to, an industrial classification, a country, a company ID, a category, or a combination of two or more of them.

When the weight of a path is calculated by, as described above, replacing a value that is multiplied in passing through an edge, using a tag representing a company ID can calculate the influence level different from an indirect shareholding ratio. Let F be selected as a designated tag value in the shareholding network in FIG. 33. In this case, the weight of a tag transition pattern is equal to the weight of a path; here, three paths ABF, ACF, and ADCF include the company F. The influence-level calculating unit 115 can thus calculate the influence level of the company F as 0+0.3+0.3=0.6, which is the sum of the weights of these three paths. This value is equal to the power index of the company F with respect to the company A. That is, using the technique according to this embodiment and using a company ID as a tag can determine the power index of each company within a network. It is noted that how to calculate the power index is described in Japanese Patent Application No. 2021-176910, entitled “INFORMATION PROCESSING SYSTEM, INFORMATION PROCESSING METHOD, AND PROGRAM”, filed on Oct. 28, 2021. This patent application is incorporated in the Specification by reference in its entirety.

For instance, the influence-level calculating unit 115 may obtain, as a selection condition, a designated tag value including a combination of the category and country of a shareholder (e.g., a first category and a first country). The influence-level calculating unit 115 selects a tag transition pattern having a tag value corresponding to the first category and first country in positions corresponding to end nodes in the shareholding network, and the influence-level calculating unit 115 adds the weight of the selected tag transition pattern. The end nodes in the example in FIG. 33 are the nodes E, F, G, and H. The positions corresponding to the end nodes are the position of Tier 3 on each of the paths ABE, ABF, ACF, ADG, and ADH, and the position of Tier 4 on the path ADCF. In other words, a position corresponding to an end node indicates a tier that is the farthest from a reference node (the top) of tiers having values (tag values) in a tag transition pattern.

Doing so enables the influence-level calculating unit 115 to calculate, for an entity belonging to the first category of the first country, the influence level expressed by a power index. Further, the influence-level calculating unit 115 may calculate weights for all combinations of the categories and countries of shareholders. In this case, the influence level expressed by the power index is obtained for each shareholder's category and country.

3.3 Case where there is Multiple Entities of Interest

The foregoing has described an instance where the entity corresponding to the node A, which is one end of a processing target network, is an entity of interest. That is, the foregoing has described an instance where there is one entity of interest.

However, there is conceivably a demand for integrating a plurality of analysis target companies and assessing the influential power of some event upon them, rather than limiting the scope of analysis to a single company. Accordingly, the information processing system 10 according to this embodiment may receive inputs of a plurality of entities of interest.

For instance, reference is made to an instance where there are five companies A to E, and the information processing system 10 calculates how much some event occurring upstream of their supply chain networks influences the whole of the companies A to E. The network extracting unit 114 in this case extracts five supply chain networks corresponding to the respective companies A to E from a trading network, like in the earlier described example. Moreover, the influence-level calculating unit 115 specifies a network for use in influence level calculation by integrating these supply chain networks together.

FIG. 34 illustrates a network example for use in the influence level calculation. First, a virtual node X is set as Tier 0. Moreover, nodes corresponding to a plurality of entities of interest are set as nodes of Tier 1 connected directly to the virtual node X. The nodes of Tier 1 are herein five nodes A to E corresponding to the companies A to E. In FIG. 34, w1 to w5 denote the weights of branches provided to the respective edges, and when divided equally, all the values stand at ⅕. Further, the weights of the branches do not necessarily have to stand at an equally divided value; such a set of positive numbers as to satisfy w1+w2+w3+w4+w5=1 may be used.

The influence-level calculating unit 115 thus generates a network by connecting, to Tier 2 and the subsequent tiers, a network with which supply chain networks starting from the individual nodes of Tier 1 are merged. This merger herein corresponds to processing to integrating common nodes into one when, for instance, such common nodes are included in two or more of five supply chain networks determined independently. Although the foregoing has described using a supply chain network (second network 122) by way of example, a trading network (first network 121) may be used. In addition, a target network may be another network, such as a shareholding network.

Processing after the processing target network is obtained is similar to that earlier described. That is, the influence-level calculating unit 115 calculates the influence level of an event corresponding to a selection condition by performing processing to calculate the weights of paths, calculate the weights of tag transition patterns, receive the selection condition, add the weight of a selected one of the tag transition patterns, and other processing.

This can calculate the influence level exerted upon the whole of the companies A to E. For instance, let the companies A to E be major automakers, and let a combination of a country and a battery-supply company be input as a designated tag value. In this case, an assessment can be made, such as a comparison between “the influence level of a Chinese battery-supply company” upon the major automaker group and “the influence level of a U.S. battery-supply company” upon the same.

This embodiment has been detailed as described above. A person skilled in the art will readily appreciate that many modifications are possible without substantially departing from the new matter and advantageous effects of the present embodiment. Accordingly, all such modifications are included in the scope of the present disclosure. For instance, terms appeared at least once in the Specification or in the drawings along with other broader or synonymous terms can be replaced with the other broader or synonymous terms in any part of the Specification or the drawings. Further, all combinations of this embodiment and its modifications are encompassed in the scope of the present disclosure. Furthermore, the configurations and operations of the information processing system, server system, terminal device, and others are not limited to those described in this embodiment. Their modifications are possible in various manners.

What is claimed is:

1. An information processing system comprising:
a network obtaining unit configured to obtain a first network in which a plurality of nodes corresponding one-to-one to a plurality of entities are connected together by edges each representing a trading relationship or a control relationship; and
an influence-level calculating unit configured to calculate an influence level in a part or whole of the first network,
wherein each of the plurality of nodes included in the first network is provided with a tag including one or more of a plurality of tag values, and
wherein for each of a plurality of paths including a reference node corresponding to an entity of interest in the first network, the influence-level calculating unit performs processing to
determine a weight of the path in accordance with the trading relationship or the control relationship between the plurality of nodes on the path,
determine weights of one or more tag transition patterns by determining the one or more tag transition patterns in accordance with the one or more tag values of the node on the path, the one or more tag transition patterns each representing a transition of the one or more tag values along the path, and by distributing the weight of the path in accordance with a determined number of tag transition patterns, and
upon receiving a given selection condition including at least a designated tag value, determine the influence level exerted upon the entity of interest in accordance with the weights of the one or more tag transition patterns selected based on the given selection condition.

2. The information processing system according to claim 1, further comprising
a network extracting unit configured to extract, as a second network, a part of the first network composed of the plurality of nodes whose distances from the reference node are equal to or smaller than a given threshold,
wherein the influence-level calculating unit determines the influence level in the second network.

3. The information processing system according to claim 2, further comprising
a vector obtaining unit configured to select any one of the plurality of nodes in the first network as a vector-calculation target node, and determine, for each of the plurality of nodes, a complex vector by assigning a complex number, the complex vector representing a relationship of the vector-calculation target node with another one of the plurality of nodes, the complex number having a phase corresponding to a distance to the vector-calculation target node, and an absolute value corresponding to an amount of flow going to or coming from the vector-calculation target node,
wherein the network extracting unit extracts the second network from the first network in accordance with the complex vector representing each of the plurality of nodes.

4. The information processing system according to claim 2, wherein
the first network is a trading network in which the plurality of nodes corresponding one-to-one to a plurality of companies are connected together by the edges each representing the trading relationship, and
the second network is a supply chain network representing a supply chain of a company of interest.

5. The information processing system according to claim 1, wherein
the first network is a shareholding network in which the plurality of nodes corresponding one-to-one to the plurality of entities are connected together by the edges each representing the control relationship determined by a shareholding ratio.

6. The information processing system according to claim 1, further comprising
a treemap generating unit configured to generate a treemap with an arrangement of figures each having an area corresponding to the influence level calculated by the influence-level calculating unit.

7. The information processing system according to claim 1, wherein
upon receiving the given selection condition to select the designated tag value and a distance from the reference node, the influence-level calculating unit determines the influence level of the one or more tag values at a predetermined distance from the reference node in accordance with the weights of the one or more tag transition patterns in which the designated tag value is included in a location specified by the distance from the reference node.

8. The information processing system according to claim 1, wherein
the tag is information indicating an industrial classification, and
upon receiving the given selection condition including a first industrial classification as the designated tag value, the influence-level calculating unit calculates the influence level of the first industrial classification in accordance with the weights of the one or more tag transition patterns including the one or more tag values corresponding to the first industrial classification.

9. The information processing system according to claim 1, wherein
the tag is information indicating a country, and
upon receiving the given selection condition including a first country as the designated tag value, the influence-level calculating unit calculates the influence level of the first country in accordance with the weights of the one or more tag transition patterns including the one or more tag values corresponding to the first country.

10. The information processing system according to claim 1, wherein
the tag is information for specifying a combination of an industrial classification and a country, and
upon receiving the given selection condition including a combination of a first industrial classification and a first country as the designated tag value, the influence-level calculating unit calculates the influence level of the first industrial classification of the first country in accordance with the weights of the one or more tag transition patterns including the one or more tag values corresponding to the combination of the first industrial classification and the first country.

11. The information processing system according to claim 1, wherein
the tag is information indicating a company corresponding to the node, and
upon receiving an input to designate a first company of interest, a second company of interest, and a third company of interest, the influence-level calculating unit calculates the influence level at which the third company of interest influences the first company of interest via the second company of interest, in accordance with the weights of the one or more tag transition patterns in which the one or more tag values of the second company of interest are between the one or more tag values corresponding to the first company of interest and the one or more tag values corresponding to the third company of interest.

12. The information processing system according to claim 1, wherein
the tag is information indicating a category of an entity corresponding to the node,
the category includes at least two or more of an individual, a business company, an investment company, a public agency, and a stock holding association, and
upon receiving the given selection condition including a first category as the designated tag value, the influence-level calculating unit calculates the influence level of the entity belonging to the first category in accordance with the weights of the one or more tag transition patterns including the one or more tag values corresponding to the first category.

13. The information processing system according to claim 1, further comprising
a network updating unit configured to update the first network including a loop by removing the loop.

14. The information processing system according to claim 2, further comprising
a network updating unit configured to update the second network including a loop by removing the loop.

15. A method of information processing that is performed by an information processing system, the method comprising:
obtaining a first network in which a plurality of nodes corresponding one-to-one to a plurality of entities are connected together by edges each representing a trading relationship or a control relationship; and
calculating an influence level in a part or whole of the first network,
wherein each of the plurality of nodes included in the first network is provided with a tag including one or more of a plurality of tag values, and
wherein for each of a plurality of paths including a reference node corresponding to an entity of interest in the first network, the information processing system performs, in calculating the influence level, processing to
determine a weight of the path in accordance with the trading relationship or the control relationship between the plurality of nodes on the path,
determine weights of one or more tag transition patterns by determining the one or more tag transition patterns in accordance with the one or more tag values of the node on the path, the one or more tag transition patterns each representing a transition of the one or more tag values along the path, and by distributing the weight of the path in accordance with a determined number of tag transition patterns, and
upon receiving a given selection condition including at least a designated tag value, determine the influence level exerted upon the entity of interest in accordance with the weights of the one or more tag transition patterns selected based on the given selection condition.
